(19) United States
(12) Patent Application Publication
(10) Pub. No.: US 2010/0230231 A1
(43) Pub. Date: Sep. 16, 2010

(54) CASH COLLECTION APPARAUTS AND SYSTEM

(75) Inventors: Sadaaki Uesaka, Fukusaki-cho (JP); Masakazu Miwa, Tokyo (JP)

Correspondence Address: DARBY & DARBY P.C., P.O. BOX 770, Church Street Station, New York, NY, 10008-0770, US

(73) Assignee: Glory Ltd., Himeji-shi (JP)

(21) Appl. No.: 12/402,640

(22) Filed: Mar. 12, 2009

(51) Int. Cl. G07F 7/04; G07F 9/10

(52) U.S. Cl. 194/206; 194/350

(57) ABSTRACT

A currency collection and processing apparatus including a housing, a coin processing module disposed in the housing and configured to store a plurality of coins, and a banknote processing unit disposed in the housing. The banknote processing unit including a banknote inlet, a banknote recognition unit, at least one banknote storing unit, and a transport unit configured to transport a banknote along a transport path connecting the inlet, the recognition unit, and the storing unit. The currency collection and processing apparatus further including an input interface, a processing control unit configured to calculate at least one of a first value representing the plurality of coins stored in the coin processing module and a second value representing the received banknotes, and to process at least one of the inputted data and the first and second calculated values, and an output device configured to output information to a user.

### TECHNICAL FIELD

The present invention relates to a cash collection apparatus, and a technique associated therewith.

### BACKGROUND ART

Conventionally, a movable cash collection apparatus for collecting banknotes and coins has been used. For example, Japanese Utility Model No. 2560630 describes an accounting apparatus which moves among a plurality of vending machines so as to collect coins stored in each vending machine. Japanese Laid-Open Patent Publication No. 5-76636 describes a counting apparatus which moves among a plurality of slot machines so as to collect tokens stored in each slot machine. Japanese Laid-Open Patent Publication No. 8-180247 describes a cash collection device which moves among a plurality of arcade game machines which include slot machines so as to collect coins and banknotes stored in each arcade game machine.

The conventional cash collection apparatus simply collects, recognizes, and counts cash. When cash is collected from a plurality of cash storing apparatuses such as vending machines and slot machines, the conventional cash collection apparatus is not used to verify an amount of cash to be collected from each apparatus.

### SUMMARY

An aspect of the present invention provides an improved method and an apparatus capable of facilitating and accurately executing a process and a task for collecting cash stored in a plurality of cash storing apparatuses such as registers.

Another aspect of this invention provides an improved method and an apparatus capable of executing a process and a task for verifying whether or not an amount of collected cash matches an amount of cash indicated by inputted data.

Another aspect of this invention provides an improved method and an apparatus capable of executing a process and a task for preparing a necessary change fund.

An embodiment of the present invention provides a currency collection and processing apparatus, including a housing, a coin processing module disposed in the housing configured to store a plurality of coins, a banknote processing unit disposed in the housing, an input interface configured to input data, a processing control unit, and an output device configured to output information to a user. The banknote processing unit comprises a banknote inlet configured to receive banknotes fed into the apparatus, a banknote recognition unit configured to analyze the received banknotes, at least one banknote storing unit, and a transport path connecting the inlet, the recognition unit, and the cassette. The processing control unit calculates at least one of a first value representing the plurality of coins stored in the coin processing module and a second value representing the received banknotes, and processes at least one of the inputted data and the first and second calculated values.

In one embodiment, the housing includes wheels so as to freely move the apparatus. The wheels are preferably driven by a motor or the like. The input interface includes a communication interface so as to receive data via wired or wireless connection. The received data includes information of a change fund and/or an anticipated value of currency to be collected by the apparatus. The processing control unit compares the anticipated value with the amount of currency collected by the apparatus. Further, the processing control unit calculates a value of change fund so as to prepare and allocate a necessary change fund to registers and the like.

A further aspect according to the present invention includes at least one cash storing apparatus having a communications interface and the currency collection and processing apparatus.

In one embodiment, the system further comprises a central server, such as a POS server, communicating with the currency collection and processing apparatus and the at least one cash storing apparatus such as POS register. Further, at least one of the currency collection and processing apparatus, the at least one cash storing apparatus, and the central server is in communication with another server such as a management server which is used in a headquarters for managing sales of shops, an armored car services company for collecting cash from the shops, a financial institution for updating account information or the like.

### BRIEF DESCRIPTION OF THE DRAWINGS

The present invention will be more readily understood from the detailed description of exemplary embodiments presented below in conjunction with the accompanying drawings, in which:

FIG. 1A is a side, partial cross-section view of an embodiment of a cash collection apparatus of the present invention;

FIG. 1B is a front view of the cash collection apparatus of FIG. 1A;

FIG. 2 is a block diagram of a cash collection system according to an embodiment of the present invention;

FIG. 3 is a block diagram of a cash collection apparatus according to an embodiment of the present invention;

FIG. 4A is a is a side, partial cross-section view of an embodiment of a cash collection apparatus of the present invention;

FIG. 4B is a is a front view of the cash collection apparatus of FIG. 4A;

FIG. 5A is a is a side, partial cross-section view of an embodiment of a cash collection apparatus of the present invention;

FIG. 5B is a is a front view of the cash collection apparatus of FIG. 5A;

FIG. 6A is a is a side, partial cross-section view of an embodiment of a cash collection apparatus of the present invention;

FIG. 6B is a is a front view of the cash collection apparatus of FIG. 6A;

FIG. 7A is a is a side, partial cross-section view of an embodiment of a cash collection apparatus of the present invention;

FIG. 7B is a is a front view of the cash collection apparatus of FIG. 7A; and

FIG. 8 is a block diagram of a cash collection apparatus according to an embodiment of the present invention.

### DETAILED DESCRIPTION

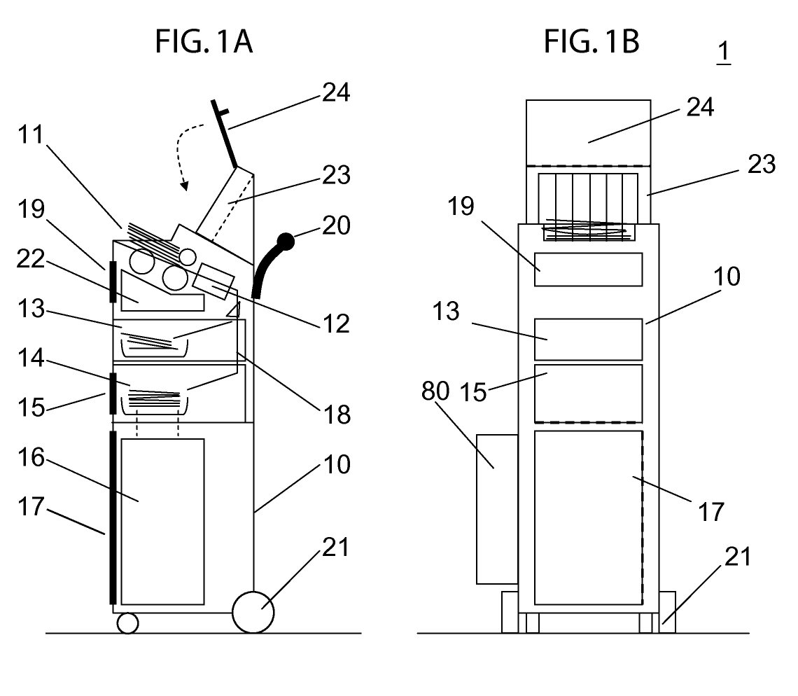

FIGS. 1A and 1B are diagrams illustrating a cash collection apparatus 1 according to an embodiment of the present invention. As shown in FIGS. 1A and 1B, the cash collection apparatus 1 includes a coin storing unit 23 for storing coins, and a housing 10 including a banknote processing unit for recognizing and counting banknotes, and storing the banknotes.

The coin storing unit 23 may be integrated with the housing 10, or the coin storing unit 23 may be detachably mounted on the housing 10.

The housing 10 includes a handle 20 and wheels 21. Therefore, a user is allowed to freely move the cash collection apparatus 1 by operating the handle 20.

According to an embodiment of the present invention, the cash collection apparatus 1 can be used for collecting cash which is stored in an apparatus such as vending machine, slot machine, arcade game machine, register or the like, and/or prepare a change fund for them.

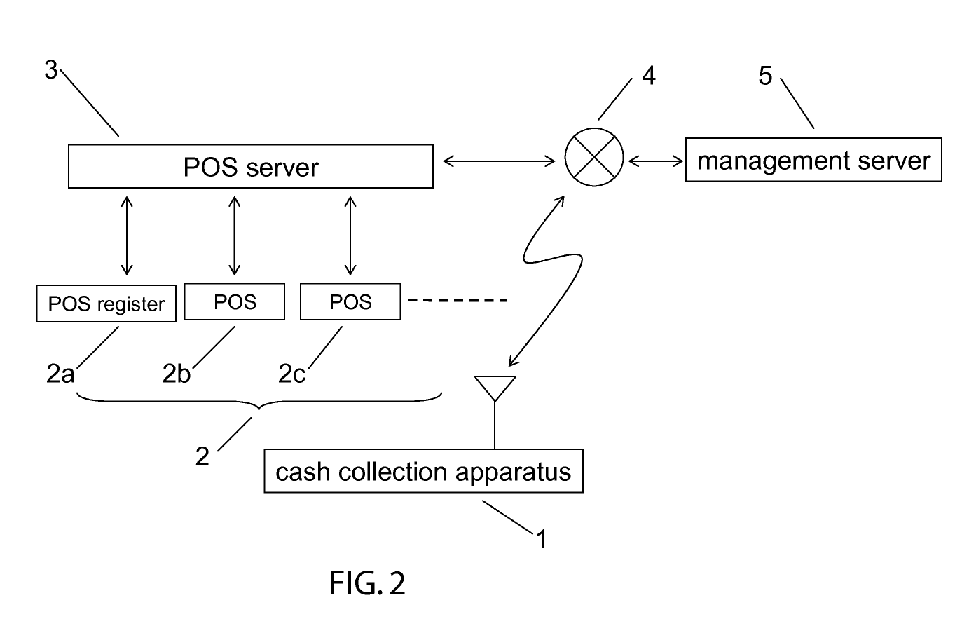

Hereinafter, with reference to FIG. 2, the cash collection apparatus 1 for collecting cash which is stored in a plurality of POS registers (hereinafter, simply referred to as “registers”) 2 mounted in a shop or the like will be described as an example.

Cash stored in registers 2 provided in a retail shop and the like is closely managed.

Specifically, cash deposited into registers 2 and cash dispensed from the registers 2 are managed by using a POS server 3. Verification as to whether or not an amount of cash stored in each register 2 matches an amount of cash which is represented by data recorded in the POS server 3 is important for managing sales.

The registers 2 each have a function of transmitting, to a POS server 3 having a wired or wireless connection thereto, information associated with commodities which are handled in transaction by means of the registers 2, and information representing particulars associated with cash deposit and dispensing. Similarly, the POS server 3 has a function of transmitting the information representing the particulars associated with the cash deposit and dispensing, through a network 4 to which the POS server 3 has a wired or wireless connection, to a management server 5 for managing sales of each shop, and the like.

The cash collection apparatus 1 according to the present invention may be effectively used in, for example, a shop which has a plurality of the registers 2 and has no server or the like, as well as in a large store having the management server 5 or the like. The management server 5 is not limited to a management server in a shop. The management server 5 may be, for example, a server used in an armored car services company for collecting cash from shops, or a server used in a financial institution, such as a bank, in which the collected cash is deposited. Data transmission and reception is performed between the cash collection apparatus 1 and the server of the armored car services company and/or the server of the financial institution, thereby enabling improvement of efficiency of a process, and the like.

A configuration, an operation, and an advantage of the cash collection apparatus 1 will be described below in detail. With reference to FIGS. 1 to 3, components of the cash collection apparatus 1 will be described.

Firstly, the coin storing unit 23 will be described.

The coin storing unit 23 stores coins collected from each register 2, and coins to be supplied to each register 2 which is to be replenished with a necessary change fund. The coin storing unit 23 stores the coins by stacking the coins in slot sections. The slot sections are provided in a body of the coin storing unit 23, and each slot section has an almost semicircular cross section. The slot sections for storing collected coins and the slot sections for storing a change fund are easily distinguishable from each other by using, for example, different numerals, characters, marks, colors, or the like.

The coin storing unit 23 has a door 24 which is openable and closable. Therefore, dropping of coins stored in the coin storing unit 23 from the slot sections due to vibration or the like may be prevented.

The door 24 may be freely opened and closed, or the door 24 may have a lock installed therein such that coins may be extracted only when the door 24 is unlocked. Alternatively, the lock installed in the door 24 may be electronically and/or magnetically controlled such that the door 24 is automatically unlocked only when coins are to be extracted or stored. Still alternatively, an operation of the door 24 itself may be controlled so as to be automatically opened and closed.

The slot sections are provided so as to correspond to coin denominations, respectively. The coins collected from each register 2 are stored in the slot sections such that the coins of the same denomination are stacked in the corresponding one of the slot sections.

For example, each slot section is marked with a scale, and indicator lines of the scale are provided at positions corresponding to the heights, respectively, each of which is to be reached by a predetermined number of coins stacked. That is, each slot section is marked with the scale depending on the thickness of a coin of each denomination to be stored. Specifically, for example, in the slot section for storing 25-cent coins, the indicator line indicating “20 coins” or “five dollars” is provided at a position corresponding to a height reached by stacking 20 coins. A user is able to confirm the number of and the total sum amount of stacked coins, by reading an indicator line of the scale which indicates a position corresponding to the height of the stacked coins.

The coin storing unit 23 is configured such that the slot sections for storing coins used as a change fund for each denomination are replenished with the necessary change fund, that is, the slot section for the necessary denomination is replenished with a predetermined number of coins of the corresponding denomination, before cash collection is started. Therefore, the coin storing unit 23 may be used for extracting the predetermined number of coins of necessary denomination, from the corresponding slot section, as the change fund to be supplied to each register 2 which is to be replenished with the necessary change fund, as well as for collecting cash from each register.

The slot section provided for each denomination is marked with the scale based on the number of coins to be supplied to one register as a necessary change fund. Therefore, a user is able to easily replenish, in accordance with the scale, the coin storing unit 23 with coins for a required number of registers. Further, a user is able to easily extract coins necessary for one register, from the coin storing unit 23, in accordance with the scale, and replenish the register 2 with the coins used as the change fund.

Specifically, when the number of 10-cent coins required as the change fund for one register is 50, the slot section for storing 10-cent coins is marked with the indicator lines of the scale at intervals of the thicknesses corresponding to 50 coins. Further, each indicator line of the scale has, for example, a sequential number associated with the number of registers. Therefore, when a change fund for three registers is necessary, 10-cent coins may be stacked up to a position of the indicator line indicating, for example, “register 2c” among registers 2a, 2b, and 2c representing a height of one register, a height of two registers, and a height of three registers, respectively. Moreover, also when each register 2 is replenished with the change fund, the coins stacked up to a position of the indicator line representing coins for one register may be extracted and supplied, without counting the coins. Therefore, a user is able to easily perform, with accuracy, a task of preparing coins which are necessary as the change fund, and a task of replenishing the register 2 with the change fund, in accordance with the scale indicated on the slot section, without counting the coins.

The positions of the indicator line of the scale on the slot section, the numerals, the characters, the marks, and the like indicated at positions of the indicator lines of the scale may be changed. For example, when the number of 10-cent coins used as the change fund in each register is 50 on a weekday, and on a holiday, the positions of the indicator lines of the scale set for a weekday and a holiday may be different from each other. Therefore, a user is able to easily prepare the change fund in various manners depending on usage.

Specifically, for example, an indicator line may be added to the scale of the slot section based on small indicator lines provided at intervals of a predetermined number of coins to be stacked such that the added indicator line of the scale is easily erasable. A user is able to add the indicator line to the scale at a desired position by drawing a desired indicator line with a predetermined pen or the like, so as to distinguish the added indicator line from the small indicator lines of the scale.

Alternatively, a plurality of indicator needles which are vertically slidable on the scale may be provided, and the indicator lines may be set at desired positions on the scale by sliding the indicator needles. In this case, the indicator needles may be distinguishable from each other by using different numerals, characters, marks, colors, or the like, so as to use the indicator needles in various manners depending on usage.

Still alternatively, each slot section may be marked with the indicator lines which are distinguishable from each other, at predetermined positions, respectively, such that, for example, the indicator lines provided at intervals of the thicknesses of 50 coins are colored blue for a weekday, and the indicator lines provided at intervals of the thicknesses of 80 coins are colored red for a holiday.

Moreover, a weight of one coin as well as the thickness of the coin may be used so as to determine a predetermined number or a predetermined amount of coins.

For example, the number of the coins stacked is calculated based on the weight of all the coins stacked in each slot section. The amount of the coins added as the change fund is calculated based on the weight difference and the denomination of the coins for each slot. A user is notified that a predetermined number or a predetermined amount of coins are stored in the slot section. Thus, as described above, it is possible to easily calculate the number or the amount of the coins used as the change fund accurately by stacking the coins.

Specifically, for example, while the coins are being stacked in each slot section, the cash collection apparatus 1 calculates the number of coins stacked, based on the weight of all the coins having been stacked, and notifies a user of the number of coins having been stacked, by means of the display unit 25. For example, a yellow lamp is lit up while the number or an amount of coins stacked is smaller than the predetermined number or the predetermined amount, respectively, and the lamp is turned off when the predetermined number or the predetermined amount of coins are stacked, and a red lamp is lit up when the number of stacked coins becomes greater than the predetermined number or the predetermined amount. Alternatively, these notifications are realized by means of sound and the like. As described above, whether or not the coins are insufficient is indicated to a user in an easily understandable manner, and therefore the user is able to easily prepare the coins used as the change fund accurately in a similar manner to that described above.

Further, when each register 2 is replenished with the change fund, the cash collection apparatus 1 monitors the change of the weight of all the coins having been stacked in the slot section, and calculates the number or the amount of coins having been extracted, in accordance with the weight of the coins being reduced by extracting the coins, and a user is notified of the number or the amount of the coins having been supplied to the register. By using display, sound, light, and the like, the cash collection apparatus 1 may notify the user whether or not the extracted coins are insufficient to replenish the register 2 with the necessary change fund. Also in this case, the user is able to easily replenish the register 2 with coins used as the change fund accurately, as described above.

Conventional cash collection apparatuses have, as a large main component, a processing unit for collecting, recognizing and counting coins, and also have a processing unit for banknotes. However, there is a problem that such an apparatus has its size increased, and an increased cost is necessary for such an apparatus. Therefore, some users desire that only banknotes, which have high values as compared to values of coins, be securely recognized and counted.

When the coin storing unit 23 as described above is used as a coin processing unit, increase of the size of the cash collection apparatus 1 may be prevented, thereby suppressing production cost.

Next, the banknote processing unit will be described.

Banknotes are stored in the housing 10. As shown in FIG. 1, the housing 10 includes: a banknote inlet 11 for receiving banknotes set therein; a banknote cassette 16 for storing banknotes; a banknote transport unit 18 for transporting banknotes along a transport path from the banknote inlet 11 to the banknote cassette 16; a banknote recognition unit 12 provided in the transport path; a banknote reject unit 13 connected to the transport path; and a banknote escrow unit 14 connected to the transport path. These units form the banknote processing unit for realizing the processing for banknotes.

The banknote inlet 11 is used for feeding banknotes to be collected, into the cash collection apparatus 1. Banknotes set in the banknote inlet 11 are fed one by one into the transport path of the cash collection apparatus 1.

The banknote transport unit 18 has a function of transporting, to each unit, the banknotes fed one by one through the banknote inlet 11 into the cash collection apparatus 1. For example, the banknote is transported to each unit with the banknote being held by belts and/or rollers. For example, a diverter is provided at a position at which the transport path diverts and swinging of the diverter is controlled so as to transport the banknotes to various units.

The banknote recognition unit 12 has a function of recognizing each banknote transported through the banknote inlet 11 by the banknote transport unit 18. The banknote recognition unit 12 includes various sensors each of which detects each banknote for necessary information. The bank recognition unit 12 analyzes the information acquired from the sensors so as to, for example, determine a denomination, authenticity, fitness or the like of the banknote. Based on results of the recognition and determination performed by the banknote recognition unit 12, the denominations and the number of the banknotes collected are managed, and the amount of the banknotes collected is calculated. That is, by using the function of the banknote recognition unit 12, the collected banknotes are recognized and counted.

The denomination means the kind of the banknote. For example, an image of the banknote being transported is taken and analyzed in order to recognize the denomination of the banknote. The authenticity means whether the banknote is genuine or counterfeit. For example, the banknote is analyzed for a portion printed by using magnetic ink and/or a security thread in order to determine the authenticity. The fitness means whether or not the banknote is reusable. For example, the fitness, whether or not the banknote is fit or unfit, is determined, when the banknote recognition unit 12 detects for data representing a torn banknote, a stained banknote and/or the like. A user is able to acquire information of the denominations of collected banknotes and the number of the collected banknotes, information of the amount of the banknotes and the like which are derived from the denominations and the number thereof, information indicating a counterfeit banknote which may be included in the collected banknotes, and the like, based on the result of the recognition performed by the banknote recognition unit 12.

The banknote reject unit 13 is used for returning, to a user, a banknote which cannot be stored in the cash collection apparatus 1, based on the result of the recognition performed by the banknote recognition unit 12. For example, when the banknote recognition unit 12 detects a counterfeit banknote, or detects a banknote which is not counterfeit but cannot be collected by the cash collection apparatus 1, or detects a slip of paper other than a banknote, the banknote transport unit 18 transports the banknote and the like to the banknote reject unit 13. A user is able to extract the banknote and the like transported into the banknote reject unit 13.

The banknotes determined as banknotes to be collected by the cash collection apparatus 1 are escrowed in the banknote escrow unit 14. While the banknotes are escrowed in the banknote escrow unit 14, a user is able to stop banknote collection process being performed.

Specifically, when, for example, the banknote recognition unit 12 recognizes and counts all the banknotes set in the banknote inlet 11, and the total sum amount of all the recognized and counted banknotes does not match an amount of banknotes to be collected from the register 2, a user is able to stop the banknote collection process, and extract the collected banknotes from the banknote escrow unit 14. A user is able to, for example, set the extracted banknotes in the banknote inlet 11, so as to perform recognition and counting of the extracted banknotes. As described above, the collected banknotes may be extracted, and, for example, the recognition of the banknotes may be performed again, thereby improving accuracy of the processing. Further, the recognized and counted banknotes are not directly transported into the banknote cassette 16, and therefore it is unnecessary to feed, from the banknote cassette 16, the stored banknotes when the banknotes are returned to a user due to the process being stopped. Therefore, it is advantageous that no time is needed for the feeding, and a banknote feeding mechanism need not be provided in the banknote cassette 16.

When a user inputs an instruction for continuing the process without stopping the collection process, the banknotes held in the banknote escrow unit 14 are stored in the banknote cassette 16. For example, the banknote escrow unit 14 has, at the bottom thereof, an openable and closable door, and the banknotes held in the banknote escrow unit 14 are dropped into the banknote cassette 16 when the door is opened. Alternatively, the banknotes held in the banknote escrow unit 14 may be transported into the banknote cassette 16 by the banknote transport unit 18 so as to be stored in the banknote cassette 16.

A user is able to set a criterion used for determining a banknote to be transported to the banknote reject unit 13, that is, a relationship between the result of the recognition performed by the banknote recognition unit 12 and a banknote to be transported to the banknote reject unit 13. For example, a user sets a criterion level for determining authenticity and/or fitness of a banknote. In this case, the level represented by the result of the determination for the banknote is compared with the criterion level, so as to determine a banknote to be transported to the banknote reject unit 13.

Further, a user is able to determine whether or not the banknote escrow unit 14 is to be used. When, for example, a processing speed is important to a user, the user is able to make settings such that the banknote escrow unit 14 is not used, and the banknote recognized as being genuine and fit by the banknote recognition unit 12 may be directly transported to the banknote cassette 16 without holding the banknote in the banknote escrow unit 14.

The banknote reject unit 13 has, at a front surface thereof, a stopper or the like for preventing a banknote from falling out of the housing 10, so as to securely hold the rejected banknote. Simultaneously, the stopper enables easy extraction of the banknote from the front surface of the banknote reject unit 13.

The banknote escrow unit 14 has a door 15 which is openable and closable, and the door 15 is closed while the recognition and the counting is performed, thereby preventing the transported banknotes from falling out of the housing 10. When the banknotes are extracted from the banknote escrow unit 14, a user opens the door 15 so as to extract the banknotes. The door 15 may be manually opened and closed by a user or the door 15 may be automatically opened and closed in accordance with a process being performed or a result of detection made by a sensor which is not shown.

Further, the door 15 may have a lock installed therein, and the door 15 may be manually or automatically locked and unlocked. When the door 15 has the lock installed therein, the door 15 may be locked while, for example, banknotes are recognized and counted, thereby improving security.

The banknote cassette 16 stores banknotes collected by the cash collection apparatus 1. The banknotes transported by the banknote transport unit 18 are recognized and counted by the banknote recognition unit 12. Thereafter, the banknotes are transported into the banknote cassette 16 through the banknote escrow unit 14 when the banknote escrow unit 14 is used, or the banknotes are directly transported into the banknote cassette 16 when the banknote escrow unit 14 is not used, as described above, and the transported banknotes are stored in the banknote cassette 16.

When, for example, the door provided at the bottom of the banknote escrow unit 14 is opened so as to drop the banknotes, an openable and closable door provided on the banknote cassette 16 opens and closes in accordance with the door of the banknote escrow unit 14 being opened and closed such that the banknotes are dropped from the banknote escrow unit 14 into the banknote cassette 16 so as to be stored in the banknote cassette 16. Alternatively, the banknotes may be transported, by the banknote transport unit 18, from the banknote escrow unit 14 into the banknote cassette 16 through a window portion provided on the banknote cassette 16.

A lower portion of the housing 10 in which the banknote cassette 16 is accommodated forms a safe. Therefore, even if the cash collection apparatus 1 is broken into, it is difficult to extract the banknotes from the housing 10, and the security for the banknote cassette 16 for storing a large amount of banknotes is improved. The safe has a safe door 17 having a lock installed therein, and only when the door 17 is unlocked, the banknote cassette 16 can be extracted from the housing 10.

The banknote cassette 16 having been extracted may be transported, as it is, to, for example, a financial institution such as a bank without extracting the banknotes from the banknote cassette 16.

Specifically, for example, the banknote cassette 16 having the banknotes stored therein is collected from the cash collection apparatus 1, and the banknote cassette 16 which contains nothing and is separately prepared is accommodated in the cash collection apparatus 1, instead of the banknote cassette 16 having been collected. The banknote cassette 16 having been collected is transported, as it is, to a financial institution or the like. Therefore, a person handling the transportation of the banknotes need not touch the banknotes, thereby preventing a mistake in a task and improving the security.

The banknote cassette 16 is detachably mounted to the housing 10, and the banknote cassette 16 moves on, for example, positioning rails provided in the housing 10 when the banknote cassette 16 is mounted to or dismounted from the housing 10. While the banknote cassette 16 is easily mounted or dismounted, a position of the banknote cassette 16 is defined by, for example, the rails, so as to securely store, in the banknote cassette 16, the banknotes dropped from the banknote escrow unit 14, or the banknotes transported by the banknote transport unit 18.

When the banknote cassette 16 has the door through which the banknotes are dropped, the door is closed when the banknote cassette 16 is extracted from the housing 10, thereby preventing the door from being easily opened and closed. Further, when the banknote cassette 16 has the window portion through which the banknotes are transported, the window portion may similarly have an openable and closable door, or the window portion may be an opening having such a size as to receive only banknotes transported one by one by the banknote transport unit 18, thereby preventing a person from putting a hand or an object in the banknote cassette 16 and preventing a person from extracting the banknote from the banknote cassette 16. As described above, easy access to the banknote stored in the banknote cassette 16 is prevented, thereby enabling improvement of security.

The housing 10 of the cash collection apparatus 1 may have various storing units in addition to those described above.

Specifically, a paper sheet storing unit 80 for storing a paper sheet, such as a check, a discount coupon, a gift certificate, other than a banknote, may be detachably mounted on a side surface of the housing 10. For example, guides or the like of the paper sheet storing unit 80 engage with corresponding guides, rails, slots, holes, or the like provided in the housing 10 so as to position the paper sheet storing unit 80, thereby fixing the paper sheet storing unit 80 to the housing 10.

A user puts a paper sheet, such as a check, from the front surface of the paper sheet storing unit 80 so as to store the paper sheet in the paper sheet storing unit 80. The paper sheet storing unit 80 has, for example, a door or a stopper for preventing the paper sheets stored therein from falling out thereof.

Depending on a usage desired by a user, the cash collection apparatus 1 may not have the paper sheet storing unit 80 mounted thereon, or two or more paper sheet storing units 80 may be provided on the side surfaces of the housing 10. The cash collection apparatus 1 used in a shop handling cash only need not have the paper sheet storing unit 80 mounted thereon. The cash collection apparatus 1 used in a shop in which paper sheets, such as checks, discount coupons, and gift certificates, are accepted may have the necessary number of the paper sheet storing units 80, depending on kinds and amounts of paper sheets to be collected, and/or a method for colleting the paper sheets.

For example, a banknote processing unit of Glory is described in Japanese Laid-Open Patent Publication No. 2001-67526 and Japanese Laid-Open Patent Publication No. 2008-242690.

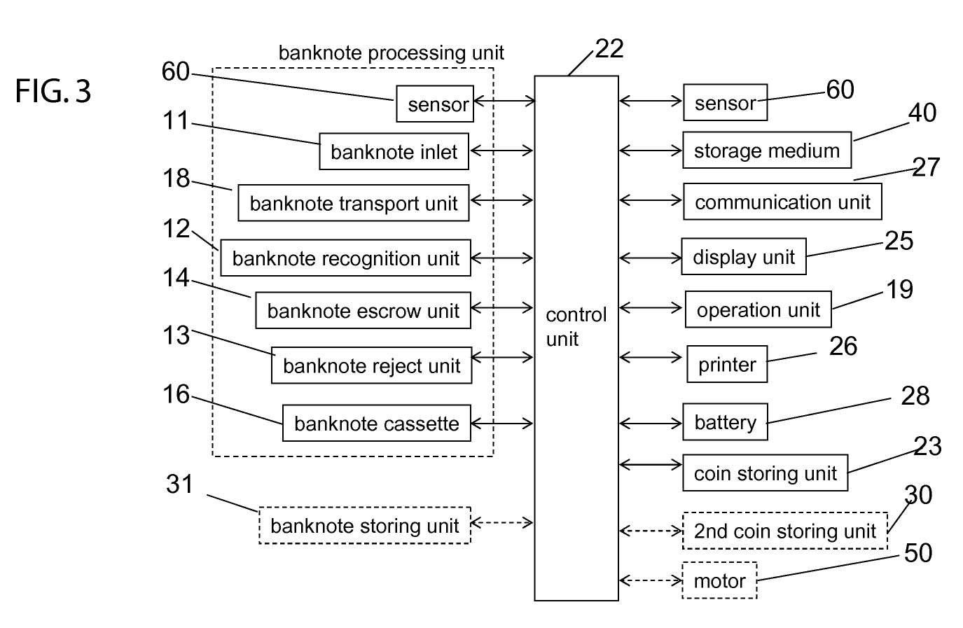

As shown in FIG. 3, the respective units operating in accordance with operations performed by other units, an operation performed by a user, and/or the like are connected to the control unit 22. The control unit 22 is a functional unit which operates by executing a predetermined software program in the CPU to which, for example, a ROM and a RAM are connected. The operations performed by the respective units described above are realized when the control unit 22 controls the respective units.

Specifically, for example, when it is detected that banknotes are set in the banknote inlet 11, based on an operation performed by a user or a signal from a sensor provided in the banknote inlet 11, the control unit 22 controls the banknote transport unit 18 so as to start feeding and transporting, one by one, the banknotes set in the banknote inlet 11.

Further, the control unit 22 analyzes, based on the settings previously made by a user, detection information of the banknote received from the banknote recognition unit 12, and controls the banknote transport unit 18 and a diverter or the like for diverting a path of the banknote from the transport path, so as to change the unit into which the banknote is to be transported, and displays the results of the recognition and/or the counting by means of the display unit 25.

Further, the control unit 22 receives a request for changing the settings based on an operation performed by a user, and stores the settings; controls the respective units based on the stored settings; starts a processing; changes a processing to be performed; stops a processing; and notifies a user of various information necessary for the user, for example.

The operation unit 19 and the display unit 25 are used when a user inputs various information to the cash collection apparatus 1, and the cash collection apparatus 1 outputs various information to a user. For example, a user uses the operation unit 19 and/or the display unit 25 so as to make settings for the control performed by the control unit 22, and confirm displayed contents of the settings. Further, the result of the recognition of the collected cash and information representing an amount of the collected cash may be displayed by the display unit 25. Further, a user is able to visually confirm a banknote which is transported to the banknote reject unit 13 as a banknote which cannot be recognized. In this case, the user may manually input the amount thereof by using the operation unit 19.

The operation unit 19 is an input device such as a key, an electronic pen, a mouse, and a touch panel. Further, the display unit 25 is a display device such as a CRT and an LCD.

The operation unit 19 may be any device into which a user is able to input information associated with settings, an instruction, and the like, and the display unit 25 may be any device by which a user is able to confirm the settings, various information representing, for example, a denomination and an amount of a banknote, and various information to be notified to a user, in such a manner as to allow a user to understand the displayed data.

For example, a functional component using an LCD touch panel or the like may function as both the operation unit 19 and the display unit 25. Further, sound, light, and/or the like may be used to input and output information. Furthermore, the operation unit 19 may be configured so as to include a plurality of input devices including, for example, a key and a touch panel. Similarly, the display unit 25 may be configured so as to include a plurality of output devices such as a display, a light, and a speaker.

The printer 26 is used to print various information, such as information representing settings for the banknote recognition unit 12, and information associated with the denomination and the amount of the collected cash, processed by the cash collection apparatus 1. The information may be printed as characters, numerals, marks, barcode, and/or the like. Further, information may be electronically and/or magnetically recorded, if a user can recognize the information later, or the information may be printed on a receipt by using ink.

The operation unit 19, the display unit 25, and the printer 26 may be a part of the housing 10. Alternatively, a part or all of the operation unit 19, the display unit 25, and the printer 26 may be separated from the housing 10, and make wired or wireless communication with the housing 10. For example, in a case where a part or all of the operation unit 19, the display unit 25, and the printer 26 is realized as a separate terminal, the terminal may be dedicated to the cash collection apparatus 1, or the terminal may be a general-purpose terminal, such as a personal computer or a PDA (Personal Digital Assistant), which communicates with the cash collection apparatus 1.

The communication unit 27 has a function of enabling the cash collection apparatus 1 to transmit various data to the POS server 3, and receive various data from the POS server 3.

Specifically, for example, data representing an amount of cash which should be stored in the register 2 from which the cash is to be collected is received from the POS server 3. Therefore, the control unit 22 is able to compare the amount of cash which has been actually collected from the register 2, and recognized and counted, with the amount of cash represented by the data which is received by the communication unit 27, and determines whether or not the amount of cash having been actually collected matches the amount of cash which is represented by the data received by the communication unit 27. Further, when the control unit 22 determines that the amount of cash having been actually collected does not match the amount of cash which is represented by the data received by the communication unit 27, the control unit 22 notifies a user thereof by means of the display unit 25 or the like.

When a conventional cash collection apparatus is used, cash is collected from a plurality of the registers, and thereafter it is necessary to verify, in a separate process and task, whether or not an amount of the cash having been actually collected matches an amount of cash which is represented by the data recorded in the POS server. When the collected cash does not match the data recorded in the POS server, it is necessary to, for example, check, for each register, a content of a receipt which is printed when the cash is collected, and specify a register at which the problem arises. Further, even after specification of the register, a user needs to, for example, go to the register at which the problem arises, and check whether or not cash is left uncollected in the register.

When the cash collection apparatus1 as described above is used, a user is able to check whether or not the collected amount of cash matches an amount of cash which is represented by data managed by the POS server 3, immediately after the collection of the cash from each register 2 is completed. Therefore, for example, a user is able to immediately perform a necessary task, such as a task of checking whether or not cash is left in the register 2, without moving to anywhere. Moreover, information associated with the collected cash may be immediately transmitted to the POS server 3 each time cash is collected from each register 2, and therefore it is unnecessary to separately input, to the POS server 3, the information associated with the collected cash after cash is collected from all the registers 2.

Although data transmission and data reception between the communication unit 27 and the POS server 3 is preferably made by wireless communication, the data transmission and data reception between the communication unit 27 and the POS server 3 may be made by wired communication. The data transmission and the data reception using wired communication may be made more securely than the data transmission and the data reception by using wireless communication, and further data transmitted by using wired communication is less likely to be received by a malicious third person/party than data transmitted by using wireless communication, thereby improving security.

Further, the communication unit 27 may communicate with another server such as the management server 5 through the network 4, or communicate with the POS register 2, as well as communicate with the POS server 3. Thus, for example, information associated with the cash which has been actually collected may be transmitted to a server of a financial institution such that the financial institution uses the information for depositing cash therein and dispensing cash therefrom, and for updating account information. Further, the information associated with the cash which has been actually collected may be transmitted to a server of an armored car services company, so as to notify the armored car services company of a time at which the cash is to be collected, and enable the armored car services company to determine how to control the collected cash.

Further, in a case where the POS register 2 has stored therein the information associated with the cash stored therein, or the like, even when the POS register 2 is unable to communicate with the POS server 3 or the POS server 3 is not used for the management or the like, the same effect as described above may be obtained. In this case, the cash collection apparatus 1 receives, from the POS register 2, necessary data associated with the amount of cash by communication between the communication unit 27 and the POS register 2. Alternatively, the necessary data may be inputted by using the operation unit 19. The cash collection apparatus 1 determines whether or not the amount of the collected cash matches an amount of cash which is represented by the data received from the POS register 2. Further, when the amount of the collected cash does not match the amount of cash which is represented by the data received from the POS register 2, the cash collection apparatus 1 is able to notify a user thereof.

Further, the communication unit 27 may be connected to a communication line such as a telephone line as well as to the network 4. Therefore, when a trouble occurs in the network 4, the communication unit 27 is able to use the communication line instead of the network 4, or when it is detected that an unusual state occurs, the unusual state may be reported to a relevant organization such as the police.

The storage medium 40 is a medium from which data is read and into which data is written. The storage medium 40 is detachably mounted to the cash collection apparatus 1. The cash collection apparatus 1 is able to read data from the storage medium 40 and write data into the storage medium 40 when the storage medium 40 is mounted.

The storage medium 40 may be any medium capable of, for example, electronically, magnetically, or optically storing data, updating data, and erasing data. A medium used as the storage medium 40 may be selected depending on usage. For example, a tape, a disk (disc), a card, a flash memory, or the like can be used as the storage medium 40.

The storage medium 40 is used for exchanging data between the communication unit 27 described above and any one of the POS server 3 or the POS register 2. For example, in a case where the use of the network 4 may cause a problem associated with security, or in a case where the POS register 2 is able to be used whereas it is difficult to use the network 4, the storage medium 40 may be used. In this case, it is possible to obtain the same effect as the effect obtained when the communication unit 27 described above is used.

Specifically, for example, necessary data stored in the POS register 2, the POS server 3, the management server 5, and/or the like is recorded in the storage medium 40 such as a USB memory. The USB memory is mounted to the cash collection apparatus 1, and therefore the cash collection apparatus 1 may read the necessary data. In this case, the cash collection apparatus 1 may perform the same operation as the operation performed when data is received by the communication unit 27.

Further, the information associated with the collected cash and the like are recorded in the storage medium 40 such as the USB memory, and, after the collection of the cash from all the registers 2 is completed, the data recorded in the USB memory are read by the POS server 3, the management server 5, and the like. In this case, the cash collection apparatus 1 may perform the same operation as the operation performed when data is transmitted from the communication unit 27.

Further, the communication unit 27 and the storage medium 40 may be used to update firmware or a software program necessary for operation of the control unit 22.

Specifically, for example, the cash collection apparatus 1 may update the software program and/or data used for the recognition, by reading and storing necessary data through the communication unit 27 or the storage medium 40. Further, the firmware and the software program in the cash collection apparatus 1 may be updated through remote-control using the network 4, for example.

The data exchanged by using the communication unit 27 or the storage medium 40 may be encrypted in a predetermined encryption scheme. In this case, only when a predetermined decryption program executable by only the cash collection apparatus 1, the POS server 3, and the management server 5, is executed, the contents of data may be decrypted. When the encryption is used, even if data to be transmitted or received is intercepted by a third person/party, the third person/party cannot understand the content of the data, thereby improving security.

The battery 28 is used for supplying power necessary for operations of the respective units shown in FIGS. 1 and 3. Although the cash collection apparatus 1 may be connected to a power supply through a power cable, the cash collection apparatus 1 may use the battery 28. Therefore, the cash collection apparatus 1 may be easily moved among the registers 2 without considering whether or not the power cable is usable. Further, it is possible to prevent loss of data being processed even if a power failure occurs while cash is collected.

The battery 28 is preferably a rechargeable power supply which is easily mounted to and dismounted from the cash collection apparatus 1. Therefore, when the cash collection apparatus 1 is not used, the battery 28 may be charged. Further, when the battery 28 is exhausted while the cash collection apparatus 1 is being used, the exhausted battery 28 may be replaced with another battery 28 having been recharged, thereby enabling continued use of the cash collection apparatus 1.

The cash collection apparatus 1 includes various sensors 60 necessary for operations of the respective units, which are not shown in FIGS. 1 and 3. The control unit 22 is capable of controlling the respective units based on detection results obtained from the sensor 60.

Specifically, for example, a sensor 60 is provided in the banknote inlet 11. In this case, when banknotes are set in the banknote inlet 11, transport of the banknotes is automatically started based on the detection result obtained from the sensor provided in the banknote inlet 11. Further, when sensors 60 are provided in the transport path, the transport of the banknotes is controlled based on the detection result obtained from the sensors 60 provided at various portions of the transport path. Further, for example, by using the sensors 60, whether or not a banknote is stored in the banknote reject unit 13 and/or the banknote escrow unit 14 may be detected, and whether the door 15 is opened or closed may be detected, thereby performing a necessary operation or notifying a user of necessary information.

An operation performed by the cash collection apparatus 1 having the configuration described above will be described.

When the cash collection apparatus 1 is used only for collecting cash from the registers 2, the cash collection is immediately started.

Further, when the cash collection apparatus 1 is used for collecting cash from the registers 2 and preparing a change fund to be stored in the registers 2, the cash collection apparatus 1 is replenished with necessary money to be used as the change fund, as necessary.

The information of money stored in the POS registers 2 is known by managing the change fund having been previously stored in the registers 2, and an amount of deposited cash and an amount of dispensed cash which are associated with sales.

For example, the POS register 2 reads a barcode attached to a commodity, and receives, from the POS server 3, information, corresponding to the barcode, which is associated with the commodity and a price of the commodity. Thereafter, the POS register 2 transmits, to the POS server 3, information of denominations and an amount of the deposited cash and the dispensed cash respectively, for example.

The POS server 3 manages the information associated with transaction by using each register 2, such as information associated with the commodity, and information associated with amounts of the deposited cash and the dispensed cash, so as to perform commodity control and sales management in a shop. The POS server 3 is able to manage the denominations and the amount of cash stored in each resister 2, based on the information of the change fund with which each register 2 is previously replenished before the transaction is started, and the information which is associated with deposit and dispensing, and is transmitted from each register 2 each time a transaction with each customer by using the register 2 is completed. Further, the POS register 2 may also manage the denominations and the amount of the cash stored therein, by managing the information associated with the change fund and the information associated with deposit and dispensing.

By using the information associated with the money stored in the register 2, the denominations and the amount of money to be supplied to the register 2 which is to be replenished with the necessary change fund may be specified.

For example, the POS server 3 or the POS register 2 specifies money to be supplied to the register 2 which is to be replenished with the necessary change fund, and the cash collection apparatus 1 receives the result of the specifying, and displays the result by means of the display unit 25. Further, the cash collection apparatus 1 may receive, from the POS server 3 or the POS register 2, information of money stored in the register 2, and may specify money to be supplied to the register 2 with the necessary change fund and display the information associated with the money to be supplied.

Hereinafter, a process and a task of replenishing the cash collection apparatus 1 with the change fund will be described.

For example, when a user inputs a predetermined instruction to the cash collection apparatus 1, the cash collection apparatus 1 receives information of the denominations and an amount of cash stored in each register 2, through the communication unit 27, from the POS server 3 or the like.

Subsequently, the cash collection apparatus 1 displays, by means of the display unit 25, information for instructing a user to input information of the denominations and the amount of cash to be prepared as the change fund in each register 2. The user checks the information displayed by the display unit 25, and inputs necessary information by using the operation unit 19. The information of the denominations and the amount of cash to be prepared as the change fund may be previously stored as data in the POS server 3, the POS register 2, or the cash collection apparatus 1, or may be received as necessary data through the network 4 or the storage medium 40.

Next, the cash collection apparatus 1 compares the information of the money stored in the POS register 2 with the information of money necessary for preparing the change fund; specifies, each denomination and an amount of money necessary to make up for the shortfall in the total sum amount to be stored in each register 2; and displays, by means of the display unit 25, information for instructing a user to supply the money necessary to make up for the shortfall to the coin collection apparatus 1.

A user checks information displayed by the display unit 25, and supplies only the money necessary to make up for the shortfall in the total sum amount to be stored in each register 2, for each denomination of coin and banknote, so as to replenish the coin storing unit 23 with the necessary change fund, and thereafter the cash collection from each register 2 is started.

Conventional cash collection apparatuses prepare a change fund by using collected cash. However there is a problem that when a large amount of coins of a certain denomination are dispensed, the certain denomination of coins may become insufficient to prepare the change fund, so that the necessary change fund may not be prepared.

When the cash collection apparatus 1 is used, the coins used as the change fund are stacked in a predetermined slot section, in the coin storing unit 23, for storing the change fund as described above. Therefore, it is possible to prevent the change fund from lacking while cash is collected and the change fund is supplied. In a case where more money than is necessary is prepared in order to prevent the change fund from lacking, some money may be left unused when the entire task is completed. The cash collection apparatus 1 as described above enables prevention of such a state.

As a method for exchanging data between the cash collection apparatus 1 and any one of the POS register 2, the POS server 3, or the like, a method in which the communication unit 27 transmits and receives data through the network 4 may be used, or a method in which data may be inputted into and outputted from the storage medium 40 so as to exchange data may be used. Alternatively, a user is able to input data by using the operation unit 19. In the following description, data is exchanged between the cash collection apparatus 1 and any one of the POS register 2, the POS server 3, or the management server 5 by using one of the aforementioned methods. However, the data may be exchanged therebetween by using the other method in practice.

Further, in the present embodiment, the cash collection apparatus 1 is used for preparing the change fund, for each denomination of coin and banknote, based on an amount of money which is stored in each register 2. However, the present invention is not limited thereto. For example, the money to be supplied, from the cash collection apparatus 1, to the registers 2 which are to be replenished with the necessary change fund may be prepared without using the money to be collected from the registers 2 and stored in the cash collection apparatus 1.

In other words, all the money collected from the registers 2 may be stored in the cash collection apparatus 1 without being used, as the change fund, and the registers 2 may be replenished, by using the cash collection apparatus 1, with the change fund which is separately prepared without considering the money stored in the registers 2.

Specifically, when the change fund is prepared and stored in the cash collection apparatus 1, information representing money necessary as the change fund is displayed by the display unit 25 regardless of the money stored in the registers 2, and a user prepares the change fund corresponding to money represented by the displayed information. At this time, the scale indicated on the coin storing unit 23 as described above is used so as to easily prepare, for each denomination, the coins for the required number of registers.

A process and a task of preparing the change fund will be described below in detail.

A user who completes a task of preparing the change fund starts collecting cash from each register 2.

Next, a process and a task of collecting banknotes from the registers 2 so as to be stored in the cash collection apparatus 1 will be described.

A user pushes the cash collection apparatus 1 having the wheels 21 by using the handle 20, so as to move the cash collection apparatus 1 to the POS register 2 from which cash is to be collected.

Next, the user inputs, by using the operation unit 19, information used for specifying the POS register 2 from which cash is to be collected. For example, the user inputs a numeral, a character, a mark, or the like which is assigned to each POS register 2 so as to be distinguishable from another POS resister 2. At this time, for example, the cash collection apparatus 1 may read a barcode, an IC tag, or the like attached to the register 2, as information for enabling the POS register 2 to be specified, so as to automatically specify the POS register 2.

When the POS register 2 is specified, the cash collection apparatus 1 receives, from the POS server 3, information of banknotes which should be stored in the POS register 2. At this time, when only the POS register 2 is used without using any server, the necessary information is received from the POS register 2. Alternatively, the necessary information may be inputted by using the operation unit 19.

The user extracts banknotes for each denomination of banknote from the POS register 2, and sets the extracted banknotes in the banknote inlet 11. The banknotes having been set is transported through the banknote inlet 11 by the banknote transport unit 18. The denomination of banknote, and the like are recognized by the banknote recognition unit 12, and the banknote is transported to the banknote escrow unit 14. The user is able to check the information, displayed by the display unit 25, representing the result of the recognition performed by the banknote recognition unit 12.

At this time, when an object other than a banknote is detected, or when a banknote which cannot be recognized, a banknote recognized as a counterfeit note, a banknote which is likely to be a counterfeit note, and the like are transported to the banknote reject unit 13 based on the predetermined criterion.

When one denomination of the banknotes have been all collected, recognized, and counted, the cash collection apparatus 1 displays, by means of the display unit 25, the total sum amount of the banknotes collected from the register 2 for the one denomination, and compares the total sum amount with a total sum amount of banknotes which is previously received, for the one denomination, as data of banknotes to be collected from the register 2.

When the total sum amount of the banknotes collected from the registers 2 matches the total sum amount of banknotes represented by the previously received data, information for instructing a user to confirm the comparison result is displayed by the display unit 25. The user confirms the content displayed by the display unit 25, and operates the operation unit 19 to approve the displayed content. When the content is approved by the user, the cash collection apparatus 1 drops the escrowed banknotes from the banknote escrow unit 14 into the banknote cassette 16, or transports the escrowed banknotes into the banknote cassette 16 by means of the banknote transport unit 18. Thus, the collected banknotes are stored in the banknote cassette 16 in the safe.

When a user does not approve the displayed content, and desires to stop the process, the user operates the operation unit 19 to input an instruction for stopping the process. When the process is stopped in accordance with the instruction inputted by the user, the cash collection apparatus 1 displays, by means of the display unit 25, information for instructing the user to extract the banknotes held in the banknote escrow unit 14 and/or the banknote reject unit 13. The user extracts the banknotes held in the banknote escrow unit 14 and/or the banknote reject unit 13 in accordance with the instruction displayed by the display unit 25, thereby enabling the process to be stopped. Thus, for example, when a user decides that the result of the recognition and the counting represents an unusual state, a user is able to easily stop the process. Further, at this time, the banknotes are held not in the banknote cassette 16 but in the banknote escrow unit 14 and/or the banknote reject unit 13, and therefore the banknote cassette 16 need not feed the banknotes having been collected, so that the user is able to immediately extract the banknotes.

Further, when banknotes and the like are stored in the banknote reject unit 13, a user is notified thereof at a predetermined time by using the display unit 25. For example, a sheet other than a banknote or a banknote other than a banknote to be collected may be extracted from the banknote reject unit 13, and the user performs a predetermined task as necessary in accordance with the extracted sheet, banknote, or the like.

When a user stops the process, the door 15 of the banknote escrow unit 14 may be automatically opened.

A user is able to determine whether or not the banknote escrow unit 14 is to be used. Further, the user is able to determine whether the banknote escrow unit 14 is to be used for the entire processes, or for some denomination of banknotes.

For example, when a small value, such as one dollar, banknotes are recognized and counted, such banknotes may be directly transported to and stored in the banknote cassette 16 without using the banknote escrow unit 14, and the banknote escrow unit 14 may be used for five-dollar banknotes, and banknotes of denomination higher than five-dollars.

For example, when 24 cents need to be actually returned, as change, to a customer in the transaction, 25 cents may be returned as change in some shops. In this case, the amount of sales of commodities does not match the amount of money stored in the register 2. Such a shop may allow a user to approve a state where, for example, the amount of all one dollar banknotes to have been stored in the register 2 does not match the amount of one dollar banknotes which have been actually collected from the register 2. In such a case, the banknote escrow unit 14 may not be used when one dollar banknotes are collected. The cash collection apparatus 1 can be used in a flexible manner.

In this case, for example, when the recognition and the counting of all one dollar banknotes are completed, a user confirms the amount of money to have been stored in the register 2, and the amount of money which has been actually collected, and even when the amount of money to have been stored in the register 2 does not match the amount of money which has been actually collected, the user approves the results of the recognition and the counting without performing any task of correcting this mismatching, and proceeds to another task.

At this time, in a case where the user approves the amount of the money having been actually collected even when the amount of the money having been actually collected does not match the amount of money recorded in the POS server 3 or the like, the amount of the money having been actually collected as well as the amount of money recorded in the POS server 3 or the like are recorded in the POS server 3. The information of the amount of the money having been actually collected is used in a subsequent process.

Furthermore, a user is able to determine whether or not an operation for approval is to be performed. For example, a user predetermines, for one dollar banknote, an allowable difference between the collected amount and the recorded amount, and, when the difference is not greater than the allowable difference, the operation for approval may be omitted. In this case, the cash collection apparatus 1 displays, by means of the display unit 25, the total sum amount of one dollar banknotes having been recognized and counted, the total sum amount of one dollar banknotes to be collected from the register 2, a difference therebetween, and information indicating that the difference is not greater than the allowable difference. The process for another denomination of banknote is started without awaiting an input, for approval by a user.

When the banknote escrow unit 14 is not used, a time for returning the banknotes having been stored is necessary if the collection process is stopped. However, for example, in a case where a predetermined difference in amount is allowed, and the difference is likely to be approved at a high rate, the process for transporting banknotes from the banknote escrow unit 14 to the banknote cassette 16 after the approval is unnecessary when the banknote escrow unit 14 is not used, and the processing time can be reduced. When the operation and process for the approval is omitted, the process and the operation are simplified, thereby enabling increased reduction of the processing time.

When the banknote escrow unit 14 is not used, the banknote cassette 16 may have a mechanism for feeding banknotes, and the banknotes may be fed from the banknote cassette 16 so as to be returned to a user when the process is stopped in accordance with an instruction inputted by the user in the process for the approval.

The operation as described above is performed for each denomination of banknote stored in the register 2, thereby collecting the banknotes from the register 2.

At this time, a user may determine the denominations of banknotes to be collected, and input, to the cash collection apparatus 1, information associated with the denominations of the banknotes to be collected. Alternatively, the cash collection apparatus 1 displays, by means of the display unit 25, the information indicating to the user the denominations of banknotes to be collected and necessary task, based on the information which represents the denominations of banknotes to be collected, and is received from the POS server 3.

When the total sum amount which is recognized and counted by the banknote recognition unit 12 does not match the amount of banknotes to be collected from the register 2, which is previously received as data, the cash collection apparatus 1 displays, by means of the display unit 25, information for instructing a user to check the difference if the settings are not made so as to allow the difference. At this time, when the banknote reject unit 13 stores a banknote or the like having been transported, the information of the stored banknote or the like is also displayed.

The user checks the information displayed by the display unit 25. When the banknote reject unit 13 stores the banknote having been transported, the user checks the banknote. When the user determines, through the visual checking, that the stored banknote is genuine, the user inputs an amount of the stored banknote by using the operation unit 19.

The cash collection apparatus 1 adds, to the total sum amount having been recognized and counted, the amount of the banknote which has been rejected by the banknote reject unit 13, that is, the amount of the banknote having been inputted from the operation unit 19 by the user. The cash collection apparatus 1 displays, by means of the display unit 25, the total sum amount obtained through the addition, and compares the total sum amount obtained through the addition, with the amount of banknotes to be collected from the register 2. When the total sum amount obtained through the addition matches the amount of banknotes to be collected from the register 2, information indicating that both the amounts match each other, and information for instructing the user to put, in the banknote escrow unit 14, the banknote having been visually checked, and approve the process, are displayed by the display unit 25. The user puts the banknote in the banknote escrow unit 14 through the door 15 having been manually or automatically opened, and performs an operation for approving the process. Thereafter, the collected banknotes are stored in the banknote cassette 16 in the safe in a similar manner to that described above for the process after the approval is performed by a user.

A banknote which is rejected by the banknote reject unit 13 may be checked after the recognition and counting of all the banknotes being processed are completed. Alternatively, when a bank note to be rejected into the banknote reject unit 13 is recognized, the banknote may be checked immediately after the recognition is completed, that is, each time a rejected banknote is checked. The visually checked banknote may be put in the cash collection apparatus 1 by using the banknote escrow unit 14, or the visually checked banknote may be set in the banknote inlet 11 by a user so as to be transported to and stored in the banknote cassette 16. In the latter case, the transported banknote may be recognized or may not be recognized by the banknote recognition unit 12. The banknote is transported to and stored in the banknote cassette 16 regardless of the recognition result.

In a case where the banknote rejected by the banknote reject unit 13 is visually checked, and an amount of the rejected banknote is manually inputted, when the amount of banknotes which have been actually collected from the register 2 does not match the amount of banknotes to be collected from the register 2, a user is able to stop the process. The user is able to extract the banknotes from the banknote reject unit 13 and the banknote escrow unit 14, and set the extracted banknotes in the banknote inlet 11, so as to recognize and count the banknotes again. Further, a user is able to perform a predetermined task for coping with such a state.

Specifically, for example, a user checks whether or not the banknote of the relevant denomination is left in the register 2, or a user may cause the cash collection apparatus 1 to record data being processed for the register 2 to be checked, and stop collecting cash, and complete the processes and tasks for the other registers 2, and thereafter resume the process having been stopped.

The processes and tasks as described above are repeated for each denomination of banknote, and, when all the banknotes stored in the register 2 have been collected, information of the collected banknotes is transmitted to the POS server 3 or the like. Further, the information may be transmitted to another server such as the management server 5, or may be stored in the storage medium 40 or a memory of the control unit 22.

When all the processes and tasks to be performed for the register 2 are completed, the cash collection apparatus 1 is moved to another register 2, and the process and task for the another register 2 is started.

Next, a process and a task for collecting a paper sheet, such as a check, other than money will be described.

The cash collection apparatus 1 may have the paper sheet collection unit 80, depending on a usage desired by a user.

For example, in a shop in which a customer is able to use a check, a discount coupon, a gift certificate, and the like, those paper sheets used in the transaction are stored in the register 2 or in a predetermined storage near the register 2. When a user collects cash from each register 2, a user is able to collect and store those paper sheets in the paper sheet collection unit 80.

When the paper sheet such as a check, a discount coupon, or a gift certificate is used in the transaction with a customer, for example, necessary information such as an amount thereof is able to be read from the paper sheet by using an apparatus, such as a scanner, provided in or connected to the POS register 2. Alternatively, a staff operating the POS register 2 may visually read necessary information from the paper sheet, and input the necessary information. The information of an amount having been inputted as described above is transmitted to and managed in the POS server 3. That is, the POS server 3 is capable of managing both information associated with the cash including coins and banknotes stored in the POS register 2, and information associated with the paper sheets other than the cash. Therefore, when a user collects banknotes and coins, the cash collection apparatus 1 is capable of displaying an amount of cash to be collected, and verifies the collected amount.

The cash collection apparatus 1 may use the information of the amount of the paper sheet managed in the POS server 3.

Specifically, for example, the cash collection apparatus 1 displays, by means of the display unit 25, information for instructing a user to collect the paper sheets, at a predetermined time. The user collects the paper sheets such as checks stored in the register 2 or in a predetermined storage, in accordance with the instruction displayed by the display unit 25, and stores the collected paper sheets in the paper sheet collection unit 80.

At this time, the cash collection apparatus 1 is capable of verifying the information of the amount of the collected paper sheets.

For example, the cash collection apparatus 1 displays, by means of the display unit 25, information for instructing a user to visually confirm the information associated with the collected paper sheets, and to input information of the visually confirmed paper sheets by using the operation unit 19. For example, the user reads an amount of the collected check, and inputs information of the read amount by using the operation unit 19 in accordance with the information displayed by the display unit 25. The cash collection apparatus 1 compares the information inputted by the user with the information previously received from the POS server 3. When the information of the amount inputted by the user does not match the information received from the POS server 3, for example, this is notified to the user by using the display unit 25 so as to instruct the user to reconfirm the amount. In response thereto, for example, the user may reconfirm the amount of the check, and perform a predetermined task such as a task of correcting the inputted amount.

The user may visually read the amount of the paper sheet such as a check, and input the read amount to the cash collection apparatus 1, or may use the banknote processing unit of the cash collection apparatus 1.

Specifically, for example, the paper sheet is set in the banknote inlet 11; the paper sheet is transported by the banknote transport unit 18; and the information of the amount of the paper sheet is read by the banknote recognition unit 12 so as to be processed as input information. The banknote recognition unit 12 has a function of reading and analyzing various information from the banknotes, so as to recognize the banknotes. This function is used to read necessary information from the paper sheet such as a check, and analyze the information so as to acquire the information of the amount.

Further, a scanner may be used as a part of the operation unit 19. In this case, the scanner is connected to the cash collection apparatus 1, and an image of the paper sheet scanned by the scanner may be inputted to and analyzed in the cash collection apparatus 1 so as to acquire the information of the amount.

As described above, by using the cash collection apparatus 1, the information associated with the paper sheet, such as a check, other than money may be compared with the information managed in the POS server 3, so as to securely perform collection process and task.

Next, a process and a task of replenishing the registers 2 with banknotes prepared as a change fund will be described.

The cash collection apparatus 1 calculates the number or the amount of banknotes to be retained as the change fund and the number or the amount of banknotes to be collected, based on the information used for specifying the register 2, and information of banknotes to be supplied to the register 2 which is to be replenished with the necessary change fund.

When a user sets banknotes, for each denomination of banknote, in the banknote inlet 11, the cash collection apparatus 1 starts recognizing and counting the banknotes. When the recognized and counted amount of the banknotes indicates an amount of banknotes to be supplied to the register 2 which is to be replenished with the necessary change fund, the cash collection apparatus 1 stops the process, and notifies a user thereof, and displays, by means of the display unit 25, information for instructing the user to supply the recognized and counted amount of the banknotes to the register 2.

In accordance with the instruction displayed by the display unit 25, the user extracts banknotes from the banknote escrow unit 14 through the door 15 which has been manually or automatically opened, and supplies the extracted banknotes to the register 2 which is to be replenished with the necessary change fund.

When the door 15 of the banknote escrow unit 14 is manually or automatically closed, the cash collection apparatus 1 causes a sensor provided in the banknote escrow unit 14 to detect whether or not a banknote is left in the banknote escrow unit 14. When a banknote is left therein, a user is notified thereof, and is instructed to extract the left banknote.

When all the banknotes to be used as the change fund are extracted, the recognition and counting which has been automatically stopped is resumed. At this time, the user may manually input an instruction for resuming the process.

When the process is resumed, the recognition and counting of all the banknotes of the denomination being processed is performed, thereby performing process for the collected banknotes as described above.

As described above, for each denomination of banknote, the recognition and counting is stopped; banknotes used as the change fund is extracted from the banknote escrow unit 14; the extracted banknotes are supplied to the register 2 so as to replenish the register 2 with the necessary change fund; and the recognition and counting is resumed. Thus, the recognition and counting of all the banknotes stored in the register 2 and the replenishing the register 2 with the necessary banknotes used as the change fund are completed.

The banknotes to be used as the change fund may be prepared in another manner other than that described above. The recognition and counting of the banknotes is stopped when the result of the recognition and counting indicates an amount to be collected by the cash collection apparatus 1, and banknotes which are left, at this time, in the banknote inlet 11 may be used as the change fund.

In this case, the banknotes left in the banknote inlet 11 as the change fund is able to be recognized and counted by the cash collection apparatus 1, after the banknotes which are held in the banknote escrow unit 14 are stored in the banknote cassette 16, as described above.

The information associated with the banknotes collected from the register 2 is transmitted through the communication unit 27 to the POS server 3 or the like. However, such information may be stored in the storage medium 40 such as a USB memory, or printed by the printer 26. Therefore, a user may use the information of the collected cash which is transmitted and received through the network 4. Further, information of the collected cash may be stored in the storage medium 40, or may be obtained as printed data, so as to cope with data fault which may occur.

Next, a process and a task of collecting coins stored in each register 2 and storing the collected coins in the cash collection apparatus 1 will be described.

The cash collection apparatus 1 displays, by means of display unit 25, information which is previously received from the POS server 3 or the like and represents the denominations of coins to be collected, and information for instructing a user to collect the coins of the denominations represented by the information.

A user collects, from the register 2, the coins of the denominations represented by the information, and stacks and stores the collected coins in a predetermined one of the slot sections provided in the coin storing unit 23 for each denomination. The user visually confirms the indicator line of the scale on the slot section, and inputs the number or an amount of the stacked coins to the cash collection apparatus 1 by using the operation unit 19.

The cash collection apparatus 1 compares the information which is inputted by the user and which represents the number or the amount of the collected coins, with the information which represents an amount of coins to be collected and which is previously received from the POS server 3 or the like.

When an amount represented by the information inputted by the user matches an amount represented by the information of the coins to be collected, a user is instructed to approve the amount.

When the user approves the amount, the user is instructed to collect coins of another denomination.

When the amount of the collected coins which is represented by the information inputted by the user does not match the amount represented by the information of coins to be collected, the user is notified thereof by means of the display unit 25, and information for instructing the user to recheck the amount is displayed by the display unit 25. The user rechecks the amount in accordance with the information displayed by the display unit 25, and corrects the inputted amount as necessary.

As described above, the coins to be collected for each denomination are sequentially displayed by the display unit 25, and the user collects the coins in accordance with the displayed instruction, and inputs the amount of the collected coins by using the operation unit 19. Therefore, all the coins are collected while the coins to be collected are being confirmed.

As described above by using an exemplary case where one dollar banknotes are collected, when an amount of banknotes to be collected from the register 2 does not match an amount of banknotes which have been actually collected from the register 2, a user may allow the difference. Also for the coins, a user is able to set the allowable difference, and the process and the task for the difference may be performed in a similar manner to that for the banknotes.

When coins are collected from one of the registers 2 and thereafter coins are collected from the other register 2, the cash collection apparatus 1 calculates an amount of the coins collected from each of the others of the registers 2, based on each amount of the coins having been already collected, and therefore a user may input, as it is, an amount or the number indicated by the indicator line of the scale on each slot section.

Specifically, for example, the number of 25-cent coins colleted from one of the registers 2 for the first time is 23, and the number of 25-cent coins collected from another one of the registers 2 for the immediately following time is 11. When a user stacks, on 25-cent coins collected for the first time, 25-cent coins collected for the immediately following time, the user knows that the number of stacked coins is “34”, based on the scale of the slot section. The user need not count the collected coins, and need not calculate the number of the coins collected from the another one of the registers 2, based on the read indicator line of the scale. The user may simply input, as it is, a number “34” which has been read from the scale. When the number, “34”, is inputted by using the operation unit 19, the cash collection apparatus 1 automatically subtracts 23 which is the number of the coins having been already collected, so as to calculate the number of coins collected from the another one of the registers 2. Thereafter, the cash collection apparatus 1 compares the number of coins to be collected from the another one of the registers 2, with the number obtained through the subtraction, and displays the result of the comparison.

As described above for the configuration of the apparatus, a user may read the number or an amount of collected coins, based on the scale, and input the read number or amount. Alternatively, the cash collection apparatus 1 may monitor the weight of coins stored in the slot section, and automatically calculate the number of stacked coins, based on the total weight of the collected coins, and the weight of one coin.

Therefore, a user is able to easily collect coins without counting the coins.

Information associated with the coins collected from the register 2 is transmitted through the communication unit 27 to the POS server 3 or the like, or may be stored in the storage medium 40 such as a USB memory, or may be printed by the printer 26. Therefore, the user is able to use, as data, the information associated with the collected coins, and the printed data may be retained so as to cope with data fault which may occur.

Next, a process and a task for preparing and storing coins used as the change fund in the cash collection apparatus 1 will be described.

The slot section of the coin storing unit 23 is marked with the scale, and the indicator line of the scale are provided at positions each corresponding to a predetermined number or amount of coins, as described above. Based on the scale, marks are previously indicated, on the slot section with which a change fund is replenished, at positions corresponding to the necessary numbers of the registers 2, respectively. The user may replenish the coin storing unit 23 with the coins based on the marks.

Specifically, for example, when the number of 25-cent coins to be supplied to each of three registers is 250, the marks are indicated on the slot section, provided in the coin storing unit 23, for storing 25-cent coins, at positions corresponding to “250”, “500”, and “750”, which represent the numbers of coins to be stored in the three registers, respectively.

Preferably, each of the marks represents a designation of the register rather than the number of coins. For example, the marks may be indicated as “register 2a”, “register 2b”, and “register 2c” at positions corresponding to “250”, “500”, and “750”, respectively. A user is able to freely set the marks as desired by the user. The user is able to use a plurality of kinds of marks for one slot section. For example, when the change fund to be prepared on a weekday is different from the change fund to be prepared on a weekend, the marks may be indicated as “weekday 1”, and “weekday 2” at positions corresponding to the respective numbers of coins to be prepared on a weekday, and the marks may be indicated as “weekend 1”, and “weekend 2” at positions corresponding to the respective numbers of coins to be prepared on a weekend such that the positions at which the marks for a weekend are indicated are different from the positions at which the marks for a weekday are indicated. Further, for example, a plurality of the slot sections are classified depending on usage, for example, depending on departments of the shop, and the marks may be indicated on each slot section at positions depending on usage for each slot section.

When a user replenishes the coin storing unit 23 with coins, the user confirms the number of the registers from which coins are to be collected, and stacks coins up to the position corresponding to the number of the registers having been confirmed. That is, when three registers are replenished with coins, a user may simply stack 25-cent coins up to a position corresponding to the mark “register 2c”. The user performs the same task for the other necessary denominations of coins. Therefore, the user is able to prepare the change fund without counting a large number of coins.

When, for example, 50 coins are wrapped as one batch into a roll shape or 50 coins are collected in a bag or the like, and 250 coins are to be prepared, five rolls of coins or five bags of coins may be stored in the slot section. That is, it is unnecessary to read the scale. However, in this case, it is preferable that, after all the coins are stacked in the slot section, a user checks whether or not the coins has been stacked up to a position of the indicator line corresponding to the number of registers to be replenished with the coins. In this case, it is possible to improve the accuracy of the task.

As described above for the configuration of the apparatus, a user may read the scale and prepare the coins, or the cash collection apparatus 1 may monitor the weight of the coins stored in the slot section, and automatically calculate the number of coins having been stacked or additionally stacked, based on the weight of one coin, and the weight of the coins which are stacked or additionally stacked in the slot section. For example, a user checks the information, displayed by the display unit 25, for indicating whether or not the stored coins are insufficient. When the displayed information indicates that coins are insufficient, the user adds coins. On the other hand, when the displayed information indicates that the coins have been excessively stored, the user removes more coins than is necessary. Therefore, it is possible to easily prepare necessary coins. At this time, the display unit 25 preferably displays the number of coins to be added or the number of coins to be removed, in addition to the information as described above.

Next, a method for replenishing the register 2 with coins prepared as the change fund by using the cash collection apparatus 1 will be described.

The cash collection apparatus 1 is moved to the register 2 for which a user needs to perform a task, and cash stored in the register 2 is collected. All the coins stored in the register 2 are collected, and thereafter a user extracts coins which are previously prepared, as the change fund, in the coin storing unit 23 so as to replenish the register 2 with the coins.

Each slot section of the coin storing unit 23 is marked with the scale so as to enable recognition of coins for one register as described above. Alternatively the number and/or the amount of the coins for one register is calculated based on the weight of the coins stacked in each slot section and notified to a user as described above. Therefore, a user is able to easily extract the coins for one register without counting the coins, and replenish the register 2 with the extracted coins.

The display unit 25 of the cash collection apparatus 1 displays, at a predetermined time, necessary information such as a message for instructing a user to replenish the register with the coins prepared as a change fund.

The display unit 25 displays the necessary information at a predetermined time, for example, after all the cash are collected from the register 2, or after the register 2 is replenished with banknotes prepared as the change fund. Further, the information displayed by the display unit 25 may be erased in accordance with a user performing a predetermined operation by using the operation unit 19, or may be automatically erased when a predetermined time has passed. By confirming the information displayed by the display unit 25, a user may not forget to replenish the register with the change fund.

The use of the cash collection apparatus 1 enables a user to easily perform a task of collecting banknotes and coins from the register 2, and a task of replenishing the register 2 with banknotes and coins prepared as the change fund. After all the tasks for the register 2 are completed, the user moves the cash collection apparatus 1 to another register 2, and the user performs the same tasks for the another register 2. The user collects cash from all the registers 2 from which the cash is to be collected, and replenishes, with the change fund, all the registers 2 to be replenished with the necessary change fund.

A user need not necessarily perform all the tasks as described above, and may perform only a part of the tasks described above depending on an intended purpose.

Specifically, depending on the number of banknotes which are left in the register 2 at the end of day, for example, five dollar banknotes may not be collected, and may be continuously stored in the register 2 as the change fund. In this case, a user may input an instruction for eliminating the process for five dollar banknotes. When the user performs a predetermined operation by using the operation unit 19, the cash collection apparatus 1 recognizes that the process is not to be performed for five dollar banknotes, and automatically eliminates information associated with five dollar banknotes, from data received from the POS server 3 or the like, and thereafter performs various process, as described above, such as a process for comparing data representing the amount of money received from the POS server 3 or the like, with data representing the amount of money which is actually collected from the register 2. Further, it is assumed that five dollar banknotes are set in the banknote inlet 11 by mistake, and the process is started. In this case, the process is stopped, and the display unit 25 displays information indicating that five dollar banknotes are to be returned to the register 2 because five dollar banknotes are not to be processed, and all the banknotes which have been transported into the cash collection apparatus 1 but are not to be processed are transported to the banknote reject unit 13. Therefore, a user extracts, from the banknote reject unit 13, five dollar banknotes which are not to be processed, and returns the extracted five dollar banknotes to the register 2, thereby enabling prevention of mistake in task.

Further, the cash collection apparatus 1 may be used only for collecting cash, and may not be used for replenishing the register with the change fund.

When the processes and tasks to be performed are previously set, the cash collection apparatus 1 sequentially displays tasks to be performed by a user, by means of the display unit 25.

Specifically, for example, in a case where banknotes other than five dollar banknote are to be collected, and coins are not to be collected, and a change fund is not to be replenished, the tasks to be performed in this case are previously inputted to and recorded in the cash collection apparatus 1. When a user moves the cash collection apparatus 1 to the register 2, and performs, by using the operation unit 19, a predetermined operation for starting the process, the display unit 25 sequentially displays the tasks to be performed by the user. For example, an instruction for collecting banknotes other than five dollar banknote is displayed, and a user starts collecting the banknotes from the register 2. Thereafter, when the confirmation of the collected banknotes and the process and task of storing the collected banknotes as described above are all completed, the display unit 25 then displays information indicating that tasks of collecting coins and replenishing the register 2 with a change fund are unnecessary. Further, the display unit 25 displays information indicating that the process and the task for the register 2 are completed as per normal, and the cash collection apparatus 1 is to be moved to another register 2 so as to perform the task for the another register 2. In accordance with the displayed information, the user starts the following tasks.

As described above, when a user performs tasks in accordance with the information displayed by the displays unit 25 of the cash collection apparatus 1, the user is able to easily perform all the tasks accurately.

Next, a process and a task performed after the cash collection apparatus 1 completes the collection of cash from all the registers 2 will be described.

When the necessary processes and tasks for all the registers 2 are completed, a user moves the cash collection apparatus 1 to, for example, an administration room of the shop.

Conventional cash collection apparatuses simply recognize and count the collected cash, and print or display the result of the recognition and the counting. However there is a problem that it is necessary to separately perform a task utilizing the result of the counting, after the cash is collected. Specifically, after the cash has been collected, it is necessary to, for example, input all the amounts which are printed for the registers, respectively, to the POS server for managing sales and the like or to a terminal connected to the POS server. It is a time-consuming task to input the amounts of cash collected from many registers while confirming each result of the printing. Further, an incorrect amount may be inputted, and, in this case, it may be necessary to determine the error.

When the cash collection apparatus 1 transmits data to and receives data from the POS server 3 or the like by wired or wireless communication, transmission and reception of necessary data associated with the collected cash and the like has been completed when the cash collection apparatus 1 arrives at the administration room. For example, when the storage medium 40 such as a USB memory is used, a user inserts, in the management apparatus such as the POS server 3, the storage medium dismounted from the cash collection apparatus 1, and data associated with the collected cash and the like are inputted. Therefore it is unnecessary to input the data manually by a user, and a mistake in task which may be made by the user may be prevented.

After cash is collected, an armored car services company collects the cash stored in the cash collection apparatus 1. For example, the cash collection apparatus 1 is actuated and starts the process, and information is transmitted, at a predetermined time, through the network 4 to a server or the like in the armored car services company such that the armored car services company recognizes that the cash needs to be collected from the cash collection apparatus 1, and starts necessary works, for example, starts preparing for collection of the cash, and starts driving to the shop.

The banknote cassette 16 which is accommodated in the safe provided at the lower part of the housing 10 may be extracted by unlocking the safe door 17. For example, an authorized manager of the shop, or a staff visiting the shop from the armored car services company unlocks the safe door 17; extracts the banknote cassette 16; stores, in the safe, a spare banknote cassette 16 containing nothing; and locks the safe door 17 again. The collected cash is stored in the banknote cassette 16, and therefore it is easy to extract cash and transport the cash to a predetermined institution such as a bank.

The safe unit includes a sensor. When the safe unit is unlocked in an abnormal way, and, for example, the safe unit is broken into, and the banknote cassette 16 is extracted, the cash collection apparatus 1 detects the abnormal state by means of the sensor, and generates an alarm by using sound or light through the display unit 25. Also when the cash collection apparatus 1 detects an abnormal state in another portion other than the safe unit, the cash collection apparatus 1 similarly generates an alarm. When a user performs a predetermined operation in response to the alarm, the cash collection apparatus 1 stops generating the alarm. When a user does not perform the predetermined operation by using the operation unit 19 within a predetermined time period so as to cancel the alarm, the cash collection apparatus 1 automatically performs a predetermined process such as a process for reporting the abnormal state through the communication unit 27 to the police. Therefore, it is possible to improve security for the cash collection apparatus 1.

When, for example, the cash collection apparatus 1 is broken into, the abnormal state is automatically reported to the police. In addition thereto, the measure to improve security for the banknote cassette 16 may be taken.

Specifically, for example, a GPS (Global Positioning System), and a communication unit capable of transmitting positional information acquired from the GPS are provided so as to be operable in the banknote cassette 16. When the banknote cassette 16 is extracted, the GPS and the communication unit automatically start operation so as to transmit the positional information indicating a position of the banknote cassette 16. The POS server 3 or the management server 5 of a shop, or a predetermined server of an armored car services company receives the positional information transmitted from the banknote cassette 16, and recognizes a position of the banknote cassette 16. Therefore, not only when the cash collection apparatus 1 is broken into and stolen, but also when a problem arises while the armored car services company are transporting the banknote cassette 16, an abnormal state may be detected based on a route by which the banknote cassette 16 is moved, thereby addressing the abnormal state. Further, when the abnormal state is reported to the police, the police is able to trace the banknote cassette 16 by using the positional information indicating a position of the banknote cassette 16.

The returned banknote cassette 16 is transported to the armored car services company, a bank, or the like by the armored car services company. The banknote cassette 16 is unlocked, and the cash stored therein is extracted, and a predetermined process such as the recognition and counting are performed.

Data representing denominations and amount of cash collected by the cash collection apparatus 1 may be transmitted and received through the network 4 or may be exchanged by using the storage medium 40 such as a USB memory. For example, when predetermined data required by the armored car services company may be inputted to a management server of the armored car services company, the armored car services company uses the predetermined data to perform their task for the cash collected from the cash collection apparatus 1.

The coins stored in the coin storing unit 23 are extracted from the coin storing unit 23, and are put in a predetermined coin cassette, a bag, or the like, and are delivered and entrusted to the armored car services company.

A receipt printed by the printer 26, the POS server 3, or the like is attached to the coin cassette, the bag, or the like.

At this time, the printed information may include information for specifying the shop from which the cash has been collected, information associated with the collected coins and banknotes, and the like. Further, the printed information may be represented as numerals, characters, barcodes, and/or the like. Moreover, the information may be electronically and/or magnetically recorded, and data may be encrypted in various encryption schemes.

Therefore, the armored car services company may easily perform their tasks for the coins extracted from the coin cassette, the bag, or the like, by using the information represented as the numerals, the characters, the barcodes, and/or the like printed on the receipt. When the information is encrypted, the security may be improved.

As described above, the use of the cash collection apparatus 1 enables a user to easily collect coins and banknotes stored in the register 2. Further, the use of the cash collection apparatus 1 enables a user to prepare the change fund and replenish the register 2 with the necessary change fund.

Moreover, the cash collection apparatus 1 displays, to a user, information indicating tasks to be performed by the user, and information associated with a problem, by means of the display unit 25, and therefore a mistake in task which may be made by the user may be prevented. Further, an amount of collected cash is compared with an amount of cash which is recorded in the POS server 3 or the like, and therefore a user is able to confirm that the cash has been appropriately collected. Even when the amount of collected cash does not match the amount of cash which is recorded in the POS server 3 or the like, the user is able to immediately perform a necessary task.

Further, the cash collection apparatus 1 includes the battery 28, and may independently operate while moving. Therefore, by using the cash collection apparatus 1, a user may freely move among a plurality of the registers 2 so as to perform tasks.

Moreover, the processed data may be encrypted, and the collected cash is accommodated in the banknote cassette 16 in the safe, thereby improving security for information and cash. Furthermore, even when an abnormal state such as theft occurs, an alarm is generated and/or the abnormal state is automatically reported to the police, thereby substantially improving security.

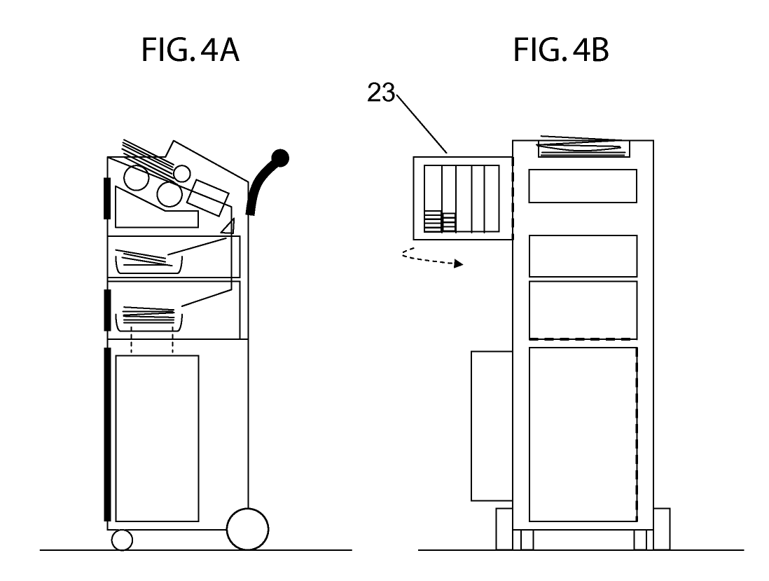

FIGS. 4A and 4B are diagrams illustrating a cash collection apparatus 1 according to another embodiment of the present invention. Components having the same functions as those shown in FIGS. 1 to 3 are denoted by the same corresponding reference numerals, respectively, as shown in FIG. 1 to 3.

The present embodiment includes the coin storing unit 23 on a side portion of the housing 10 so as to be accommodated in the housing 10.

The coin storing unit 23 pivots about a predetermined axis on the housing 10 so as to be openable and closable, and the coin storing unit 23 is accommodated in the housing 10 when the coin storing unit 23 is not used. When the coin storing unit 23 is accommodated in the housing 10, coins stacked in the slot section are securely retained so as to prevent dropping of the coins.

When, for example, necessary tasks, such as a task of preparing the change fund, a task of replenishing the register 2 with the change fund, a task of collecting coins from the register 2, and the like, are performed, the coin storing unit 23 is opened or closed as necessary. That is, when the coin storing unit 23 is used, the coin storing unit 23 projects from the housing 10.

The coin storing unit 23 may be accommodated in the housing 10 in any manner. The coin storing unit 23 may pivot about the predetermined axis as described above. Alternatively, the housing 10 and the coin storing unit 23 may be each provided with rails such that the coin storing unit 23 may be slid on the rails so as to be extracted from and retracted into (moved forward and backward) the housing 10, thereby accommodating the coin storing unit 23. Further, the pivoting movement may be combined with the extracting and retracting movement.

Further, the coin storing unit 23 may be provided at a portion other than the side portion of the housing 10. For example, the coin storing unit 23 may be provided at the top of the housing 10, at the front surface thereof, at the back surface thereof, or at any other portion.

The coin storing unit 23 may be extracted from and retracted into the housing 10 through manual operations, thereby accommodating the coin storing unit 23. Further, when the coin storing unit 23 is accommodated in the housing 10, a user may perform a predetermined operation by using the operation unit 19 so as to automatically extract from and retract into the housing 10 the coin storing unit 23 by means of a motor or the like. Further, the control unit 22 may control the coin storing unit 23 so as to be automatically extracted from and retracted into the housing 10 as necessary when a task using the coin storing unit 23 is performed.

As described above, the coin storing unit 23 is able to be accommodated in the housing 10, so as to prevent easy extraction of coins stored in the slot section, thereby enabling improvement of the security for the cash collection apparatus 1.

The structures of the other units and the operations are the same as described for the above embodiment, and the description thereof is not provided.

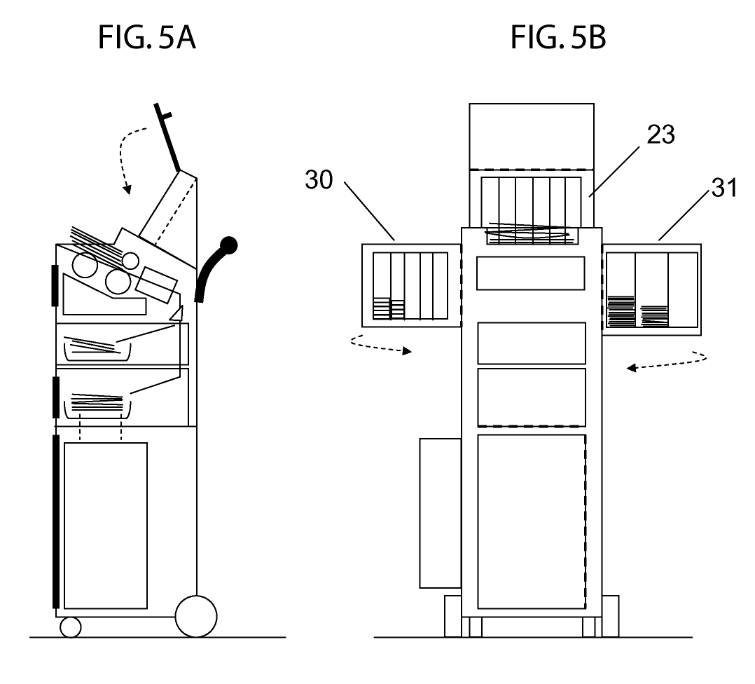

FIGS. 5A and B are diagrams illustrating a cash collection apparatus 1 according to another embodiment of the present invention. Components having the same functions as those shown in FIGS. 1 to 4 are denoted by the same corresponding reference numerals, respectively, as shown in FIGS. 1 to 4.

The present embodiment includes a second coin storing unit 30 and a banknote storing unit 31 are provided on side portions, respectively, of the housing 10.

When cash are to be collected from a large number of the registers 2, and the large number of the registers 2 are to be replenished with a change fund, or when a large amount of change fund is to be prepared, the coin storing unit 23 shown in FIG. 1 in above embodiment may not be capable of storing all necessary coins. Further, in some cases, banknotes stored in the register 2 may be insufficient, and banknotes used as the change fund may need to be prepared.

In the present embodiment, the second coin storing unit 30 is provided in addition to the coin storing unit 23, and therefore the increased number of coins are able to be stored as compared to the coin storing unit 23 described in above embodiment. For example, one of the coin storing units may be used to store coins used as the change fund, and the other of the coin storages units may be used to store coins collected from the registers 2.

Further, when the banknote storing unit 31 is provided, the banknote storing unit 31 may be previously replenished with banknotes to be supplied to the registers 2 each of which is to be replenished with a necessary change fund.

The banknotes to be replenished and used as the change fund may be prepared such that a necessary amount of banknotes are prepared in advance for each denomination of banknote separately from the collected banknotes, and the necessary amount of banknotes are stored in a storing unit provided for each denomination of banknote. At this time, a divider may be provided at intervals of the banknotes for one register so as to easily recognize the banknotes corresponding to one register 2. A user extracts only the banknotes stacked on the divider, and replenishes each register 2 with the extracted banknotes. Therefore, it is possible to easily replenish the register 2 with the banknotes to be used as the change fund without counting the banknotes.

Further, the cash collection apparatus 1 may be used to prepare, in the cash collection apparatus 1, banknotes used as the change fund.

Specifically, an amount or the number of banknotes to be supplied to the banknote storing section 31 which is to be replenished with a necessary change fund is inputted for each denomination of necessary banknote by using the operation unit 19. When one denomination of banknotes or various denominations of banknotes are set, as a batch, in the banknote inlet 11, the process is started. The banknotes are recognized and counted, and the recognized and counted banknotes are transported by the banknote transport unit 18 into the banknote escrow unit 14. At this time, banknotes which are recognized, based on its denomination, as banknotes which are not to be counted as the change fund are transported to the banknote reject unit 13. When the necessary amount of banknotes are counted, the cash collection apparatus 1 stops the process, and displays, by means of the display unit 25, information indicating that banknotes used as the change fund for one register are prepared.

A user opens the door 15, and extracts the banknotes from the banknote escrow unit 14, and replenishes the banknote storing unit 31 with the extracted banknotes, and puts a divider on the top of the stacked banknotes. When the user performs a predetermined operation for resuming the process by using the operation unit 19, the cash collection apparatus 1 displays information indicating a designation of the register for which the recognition and counting are being performed, by means of the display unit 25, and resumes the recognition and counting. At this time, in a case where, although the user inputs an instruction for resuming the recognition and counting, a banknote is left in the banknote escrow unit 14, the cash collection apparatus 1 indicates to the user that a banknote is left in the banknote escrow unit 14 without resuming the recognition and counting. In response thereto, the user checks whether or not a banknote is left, and extracts, from the banknote escrow unit 14, the banknote left therein, and thereafter the cash collection apparatus 1 resumes the recognition and counting. Thus, the user is able to easily prepare the necessary banknotes for the necessary number of registers as the change fund.

The door 15 of the banknote escrow unit 14 may be automatically opened and closed. Further, the process may be automatically resumed when it is detected that all the banknotes are extracted from the banknote escrow unit 14.

A user extracts only the banknotes put on one divider for one register 2, and replenishes the register 2 with the extracted banknotes prepared as the change fund. Therefore, the user is able to easily replenish each register 2 with the banknotes to be used as the change fund without counting the banknotes.

Further, information associated with the banknotes which are stored in each register 2 and are managed by the POS server 3 or the like may be used.

Specifically, for example, the cash collection apparatus 1 calculates, for each denomination of banknote, an amount of banknotes necessary to make up for the shortfall in the necessary change fund, based on the amount of banknotes which are left in each register 2 for each denomination of banknote and is received from the POS server 3 or the like, and the amount of the banknotes which is previously inputted for each denomination of banknote as an amount of banknotes necessary as the change fund.

A user checks a result of the calculation displayed by the display unit 25, and prepares, for each denomination of necessary banknote, necessary amount of banknotes, and replenishes the banknote storing unit 31 with the prepared banknotes. As described above, when a user sets, in the banknote inlet 11, one denomination of banknotes or various denominations of banknotes as a batch, and operates the operation unit 19, the cash collection apparatus 1 recognizes and counts the banknotes. In this case, however, the process is not stopped each time the process for the banknotes necessary for one register is completed. The banknotes of the amount necessary for all the registers 2 are prepared in the banknote escrow unit 14. In accordance with the information displayed by the display unit 25, the user prepares, as the change fund, the necessary denominations of banknotes, and replenishes the banknote storing unit 31 with the necessary denominations of banknotes, and thereafter starts tasks for collecting cash from each register and replenishing each register with the change fund.

The process and the task of replenishing the register 2 with the change fund by using the banknotes stored in the register 2 are performed in the same manner as described in the above embodiment.

When the banknotes stored in a register 2 are insufficient, the cash collection apparatus 1 displays, by means of the display unit 25, information associated with the denomination of the insufficient banknotes, and information for instructing a user to set, in the inlet, the banknotes.

In accordance with the information displayed by the display unit 25, the user extracts the necessary denominations of banknotes, at a rough estimate, from the banknote storing unit 31, and sets the extracted banknotes in the banknote inlet 11. The cash collection apparatus 1 recognizes and counts the banknotes set in the banknote inlet 11, and transports, to the banknote escrow unit 14, the banknotes of the amount necessary to make up for the shortfall in the necessary change fund.

At this time, when the banknotes set in the banknote inlet 11 are insufficient, the display unit 25 displays information for instructing the user to additionally set banknotes in the banknote inlet 11. In accordance with the information displayed by the display unit 25, the user additionally sets banknotes in the banknote inlet 11, and the process is resumed.

When the banknotes necessary to make up for the shortfall in the necessary change fund are prepared, the cash collection apparatus 1 stops the process, and displays, by means of the display unit 25, information for instructing the user to extract the banknotes from the banknote escrow unit 14, and supply the extracted banknotes to the register 2 which is to be replenished with the necessary change fund.

The user extracts the banknotes from the banknote escrow unit 14, and supplies the extracted banknotes to the register 2 which is to be replenished with the necessary change fund, and inputs, by using the operation unit 19, information indicating that the extracted banknotes have been supplied to the register 2. In response thereto, the cash collection apparatus 1 detects for a banknote held in the banknote escrow unit 14, so as to confirm that no banknotes is left. When a banknote is left, the display unit 25 displays information for instructing the user to extract the left banknote, and supply the banknote to the register 2 which is to be replenished with the necessary change fund. The cash collection apparatus 1 confirms that no banknote is held in the banknote escrow unit 14. Thereafter, the cash collection apparatus 1 transports, when banknotes are left in the transport path, all the banknotes left in the transport path, to the banknote reject unit 13. The display unit 25 displays information for instructing the user to return, to the banknote storing unit 31, the banknotes stored in the banknote reject unit 13 and the banknotes set in the banknote inlet 11.

The user extracts banknotes left in the banknote inlet 11 and banknotes stored in the banknote reject unit 13, and returns the extracted banknotes to the banknote storing unit 31.

The counting of the banknotes set in the banknote inlet 11 may be started through manual operation performed by a user or may be automatically started. The door 15 of the banknote escrow unit 14 may be manually opened and closed, or automatically opened and closed.

As described above, a user checks the information displayed by the display unit 25 and performs tasks and operations in accordance with the displayed information. Therefore, the user is able to easily replenish the register 2 with the banknotes necessary to make up for the shortfall in the necessary change fund, by storing the banknotes in the banknote storing unit 31.

The other processes and operations performed by the cash collection apparatus 1 are the same as described for the above embodiment, and therefore the description thereof is not provided.

Further, the second coin storing unit 30 and the banknote storing unit 31 are accommodated in the housing 10 in the same manner as described for the other embodiment, and therefore the description thereof is not provided.

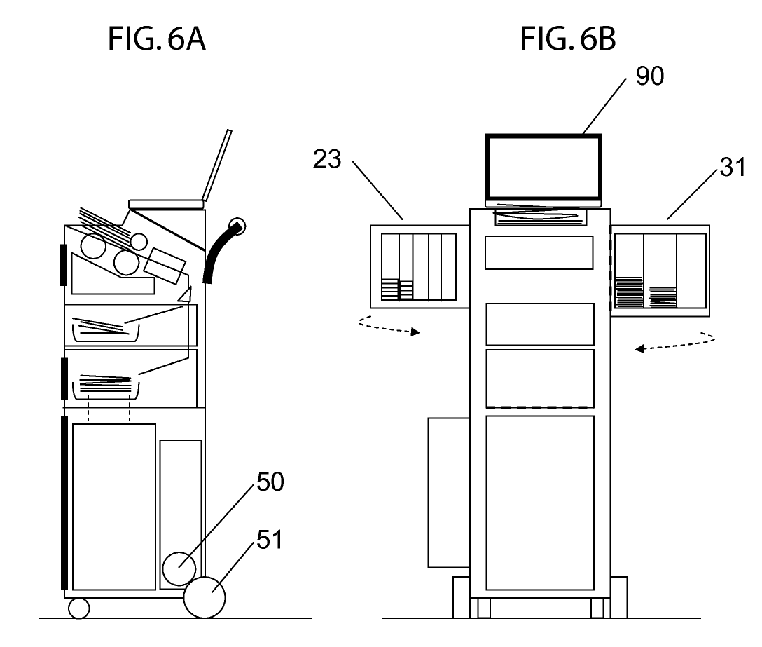

FIGS. 6A and 6B are diagrams illustrating a cash collection apparatus 1 according to another embodiment of the present invention. Components having the same functions as those shown in FIGS. 1 to 5 are denoted by the same corresponding reference numerals, respectively, as shown in FIG. 1 to 5.

The present embodiment includes wheels 51 provided on the lower part of the housing 10 that are driven by a motor 50.

In the present embodiment, the coin storing unit 23 is provided on one side portion of the housing 10 so as to be openable and closable as described for above embodiment, and the banknote storing unit 31 is provided on the other side portion of the housing 10 so as to be openable and closable as described for above embodiment. However, the present invention is not limited thereto. The cash collection apparatus 1 according to the present embodiment is realized as the cash collection apparatus which is based on any one of the above embodiments, or a combination of two or more of the above embodiments, and has the wheels 51, a portion of which is driven by a driving unit such as the motor 50, for enabling the cash collection apparatus to move.

Further, the cash collection apparatus 1 may be configured such that a control terminal, such as a computer 90, connected to the cash collection apparatus acts as the control unit 22 and controls the respective units.

For example, the computer 90 may function as both the operation unit 19 and the display unit 25 as described above.

As the control terminal 90 functioning as the operation unit 19, the display unit 25, and the control unit 22, not only the computer but also a general-purpose terminal such as a PDA (Personal Digital Assistants) for enabling execution of a dedicated software program may be used. Alternatively, a dedicated terminal may be used as the control terminal 90.

A shaft of the motor 50 and a shaft of each of the wheels 51 are connected to each other by a driving force transmission mechanism, such as gears, a belt, a chain, or the like, and each wheel 51 rotates by a driving force generated by forward rotation or reverse rotation of the motor 50.

As shown in FIG. 3, the motor 50 is connected to the control unit 22, and the rotation direction and the rotation speed of the motor 50 may be controlled by the control unit 22. The motor 50 operates by using power generated by the battery 28.

In accordance with a user operating the operation unit 19, the control unit 22 controls the operation of the motor 50 so as to move the cash collection apparatus 1 in a direction desired by the user.

For example, when a button is provided on the handle 20 as a part of the operation unit 19, the cash collection apparatus 1 may be freely controlled by pressing the button. Therefore, even when the cash collection apparatus 1 is heavy, a user is able to easily move the cash collection apparatus 1 to a desired position.

According to the present invention, the cash collection apparatus 1 may be equipped with wheels 51, caterpillars, or other commonly known devices so as to be mobile. Power to move the currency collection apparatus is provided by an operator or it may be self-driven using a motor 50 or other devices. Further, the numbers of the motor 50 and the wheels 51 provided in the cash collection apparatus 1 may not be limited to the numbers shown in FIG. 6.

Further, the part of operation unit 19 to control of drive may be, for example, a button, a stick-like component, and a pad-like component. The operation unit 19 may be provided on the handle 20 of the cash collection apparatus 1 or may be controlled by a control device which has a wired or wireless connection to the cash collection apparatus 1.

Further, the control unit 22 may automatically move the cash collection apparatus 1 by using a sensor provided in the housing 10.

Specifically, for example, lines or the like detectable by the sensor are previously drawn in a path on which a plurality of the registers 2 from which cash is to be collected and which are to be replenished with the change fund are mounted.

A user prepares the change fund in the cash collection apparatus 1, and thereafter a user inputs, by using the operation unit 19, an instruction for moving the cash collection apparatus 1. The cash collection apparatus 1 detects the lines by using the sensor, and controls the motor 50 and the right and left wheels 51 such that the cash collection apparatus 1 automatically moves along the lines.

When an object against which the cash collection apparatus 1 may collide is in the path, the sensor provided in the housing 10 detects the object, and the cash collection apparatus 1 automatically stops, and the display unit 25 displays the reason for the stop. The user checks the information displayed by the display unit 25, and removes the obstacle from the path on which the cash collection apparatus 1 is moved, and thereafter operates the operation unit 19 so as to move the cash collection apparatus 1 again.

The cash collection apparatus 1 causes the sensor to detect an obstacle, and, when the obstacle is detected, the cash collection apparatus 1 may automatically stop. In addition thereto, a user may perform an operation so as to stop the cash collection apparatus 1 in the event of an emergency. Further, in a case where the cash collection apparatus 1 stops, and then detects that the obstacle is removed by a user, the cash collection apparatus 1 may automatically move. Whether each operation is performed in accordance with a user's operation or is automatically performed is determined based on the settings made in the cash collection apparatus 1, and therefore the user may change the settings so as to cause the cash collection apparatus 1 to perform an intended operation and/or to have an intended function.

When the cash collection apparatus 1 reaches a predetermined position at which the register 2 from which cash is to be collected and which is to be replenished with the change fund is mounted, the sensor detects a mark indicating the predetermined position, and the cash collection apparatus 1 automatically stops.

The user performs a task of collecting cash and a task of replenishing the register with the change fund as described above in each embodiment. When these tasks are completed, the user inputs an instruction for moving the cash collection apparatus 1 again.

In accordance therewith, the cash collection apparatus 1 detects the line again, and automatically moves to another register 2 from which cash is to be collected and which is to be replenished with the change fund, and stops at a position at which the another register is mounted.

The cash collection apparatus 1 may automatically move in accordance with the mark such as the line, or the cash collection apparatus 1 may receive a signal transmitted from each register 2 through the communication unit 27, so as to automatically move to a position of the register 2 from which cash is to be collected and which is to be replenished with the change fund, while avoiding an obstacle detected by the sensor.

As described above, by a driving force generated by the motor 50 or the like, the cash collection apparatus 1 may be moved as intended by a user, or may be automatically moved, thereby enabling a user to easily collect cash and replenish the register 2 with the change fund.

The other processes and operations performed by the cash collection apparatus 1 are same as described for the above embodiments, and the description thereof is not provided.

Further, the second coin storing unit 30 and the banknote storing unit 31 are accommodated in the housing 10 in the same manner as described for the above embodiment, and the description thereof is not provided.

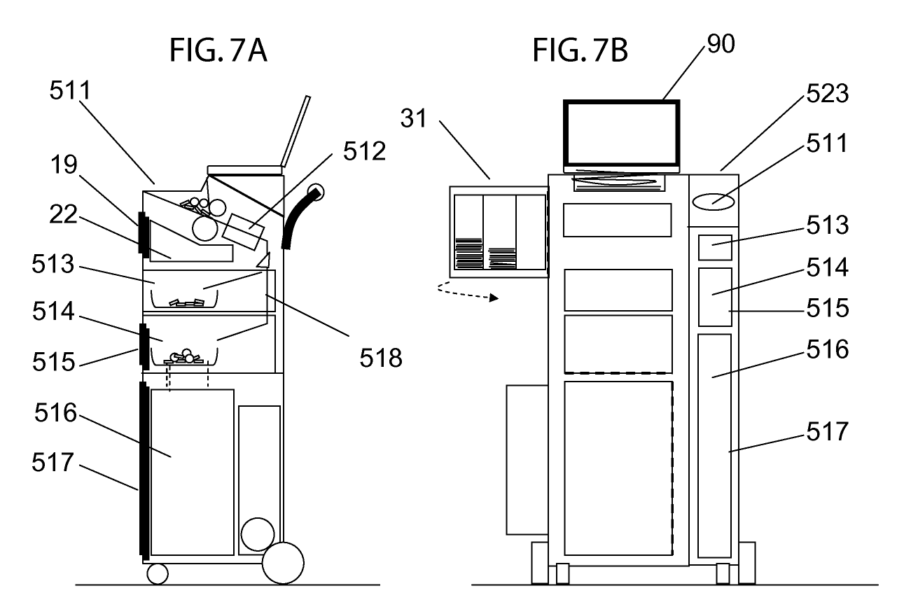

FIGS. 7A and 7B are diagrams illustrating a cash collection apparatus 1 according to another embodiment of the present invention. Components having the same functions as those shown in FIGS. 1 to 6 are denoted by the same corresponding reference numerals, respectively, as shown in FIGS. 1 to 6.

The present embodiment includes a coin processing unit is provided instead of the coin storing unit 23 provided on a side surface of the housing 10.

The coin processing unit will be described.

The coins are stored in the housing 10 provided at the lower part of the cash collection apparatus 1. As shown in FIGS. 7A and 7B, the housing 10 includes: a coin inlet 511 for receiving coins therein; a coin cassette 516 for storing coins; a coin transport unit 518 for transporting coins along a transport path from the coin inlet 511 to the coin cassette 516; a coin recognition unit 512 provided in the transport path; a coin reject unit 513 connected to the transport path; and a coin escrow unit 514 connected to the transport path. These units form the coin processing unit for realizing the processing for coins.

The coin inlet 511 is used for feeding coins to be collected, into the cash collection apparatus 1. Coins set in the coin inlet 511 are fed one by one into the transport path of the cash collection apparatus 1.

The coin transport unit 518 has a function of transporting, to each unit, the coins fed one by one through the coin inlet 511 into the cash collection apparatus 1. For example, the coin is transported to each unit with the coin being held by using belts, rollers, a centrifugal disk, and/or the like. For example, a diverter is provided at a position at which the transport path diverts, and swinging of the diverter is controlled so as to transport the coins to various units.

The coin recognition unit 512 has a function of recognizing each coin transported through the coin inlet 511 by the coin transport unit 518. The coin recognition unit 512 includes various sensors each of which detects each coin for necessary information. The coin recognition unit 512 analyzes a signal acquired from the sensors so as to, for example, recognize determine a denomination, authenticity, fitness or the like of the coin. Based on results of the recognition and determination performed by the coin recognition unit 512, the denominations and the number of the coins collected are managed, thereby recognizing and counting the collected coins.

The coin reject unit 513 is used for returning, to a user, a coin which cannot be stored in the cash collection apparatus 1, based on the result of the recognition performed by the coin recognition unit 512. For example, when the coin recognition unit 512 detects a counterfeit coin, or detects a coin which is not counterfeit but cannot be collected by the cash collection apparatus 1, or detects a fragment of metal other than a coin, the coin transport unit 518 transports the coin and the like to the coin reject unit 513. A user is able to extract the coin transported into the coin reject unit 513.

The coins determined as coins to be collected by the cash collection apparatus 1 based on the result of the recognition performed by the coin recognition unit 512 are escrowed in the coin escrow unit 514. While the coins are escrowed in the coin escrow unit 514, a user is able to stop coin collection process being performed.

Specifically, when, for example, the coin recognition unit 512 recognizes and counts all the coins set in the coin inlet 511, and the total sum amount of all the recognized and counted coins does not match an amount of coins to be collected from the register, a user is able to stop the coin collection process, and extract the collected coins from the coin escrow unit 514. A user is able to, for example, set the extracted coins in the coin inlet 511, so as to perform recognition and counting of the extracted coins. As described above, the collected coins may be extracted, and, for example, the recognition of the coins may be performed again, thereby improving accuracy of the processing. Further, the recognized and counted coins are not directly transported into the coin cassette 516, and therefore it is unnecessary to feed, from the coin cassette 516, the stored coins when the coins are returned to a user. Therefore, it is advantageous that no time is needed for the feeding, and a coin feeding mechanism need not be provided in the coin cassette 516.

When a user inputs an instruction for continuing the process without stopping the collection process, the coins held in the coin escrow unit 514 are stored in the coin cassette 516. For example, the coin escrow unit 514 has, at the bottom thereof, an openable and closable door, and the coins held in the coin escrow unit 514 are dropped into the coin cassette 516 when the door is opened. Alternatively, the coins held in the coin escrow unit 514 may be transported into the coin cassette 516 by the coin transport unit 518 so as to be stored in the coin cassette 516.

A user is able to set a criterion used for determining a coin to be transported to the coin reject unit 513, that is, a relationship between the result of the recognition performed by the coin recognition unit 512 and a coin to be transported to the coin reject unit 513. For example, a user sets a criterion level for determining authenticity and fitness of coin. In this case, the level represented by the result of the determination for the coin is compared with the criterion level, so as to determine whether or not the coin to be transported to the coin reject unit 513.

Further, a user is able to determine whether or not the coin escrow unit 514 is to be used. When, for example, a processing speed is more important to a user than the accuracy of the processing, the user is able to make settings such that the coin escrow unit 514 is not used, and the coin recognized as being genuine and fit by the coin recognition unit 512 may be directly transported to the coin cassette 516 without holding the coin in the coin escrow unit 514.

The coin escrow unit 514 has a door 515 which is openable and closable, and the door 515 is closed while the recognition and the counting is performed, thereby preventing the transported coins from falling out of the housing 10.

When the coins are extracted from the coin escrow unit 514, a user opens the door 515 so as to extract the coins. The door 515 may be manually opened and closed by a user or the door 515 may be automatically opened and closed in accordance with a process being performed or a result of detection made by a sensor which is not shown.

Further, the door 515 may have a lock installed therein, and the door 515 may be manually or automatically locked and unlocked. When the door 515 has the lock installed therein, the door 515 may be locked while, for example, coins are recognized and counted, thereby improving security.

The coin cassette 516 stores coins collected by the cash collection apparatus 1. The coins transported by the coin transport unit 518 are recognized and counted by the coin recognition unit 512. Thereafter, the coins are transported into the coin cassette 516 through the coin escrow unit 514 when the coin escrow unit 514 is used, or the coins are directly transported into the coin cassette 516 when the coin escrow unit 514 is not used, as described above, and the transported coins are stored in the coin cassette 516.

When, for example, the door provided at the bottom of the coin escrow unit 514 is opened so as to drop the coins, an openable and closable door provided on the coin cassette 516 opens and closes in accordance with the door of the coin escrow unit 514 being opened and closed such that the coins are dropped from the coin escrow unit 514 into the coin cassette 516 so as to be stored in the coin cassette 516. Alternatively, the coins may be transported, by the coin transport unit 518, from the coin escrow unit 514 into the coin cassette 516 through a window portion provided on the coin cassette 516.

A lower portion of the housing 10 in which the coin cassette 516 is accommodated forms a safe. Therefore, even if the cash collection apparatus 1 is broken into, it is difficult to extract the coins from the housing 10, and the security for the coin cassette 516 for storing a large amount of coins is improved. The safe has a safe door 517 having a lock installed therein, and only when the door 517 is unlocked, the coin cassette 516 can be extracted from the housing 10. The coin cassette 516 having been extracted may be transported, as it is, to, for example, a financial institution such as a bank without extracting the coins from the coin cassette 516.

Specifically, for example, the coin cassette 516 having the coins stored therein is collected from the cash collection apparatus 1, and the coin cassette 516 which contains nothing and is separately prepared is accommodated in the cash collection apparatus 1, instead of the coin cassette 516 having been collected. The coin cassette 516 having been collected is transported, as it is, to a financial institution or the like. Therefore, a person handling the transportation of the coins need not touch the coins, thereby preventing a mistake in a task and improving the security.

The coin cassette 516 is detachably mounted to the housing 10, and the coin cassette 516 moves on, for example, positioning rails provided in the housing 10 when the coin cassette 516 is mounted to or dismounted from the housing 10. While the coin cassette 516 is easily mounted or dismounted, a position of the coin cassette 516 is defined by, for example, the rails, so as to securely store, in the coin cassette 516, the coins dropped from the coin escrow unit 514, or the coins transported by the coin transport unit 518.

When the coin cassette 516 has the door through which the coins are dropped, the door is closed when the coin cassette 516 is extracted from the housing 10, thereby preventing the door from being easily opened and closed. Further, when the coin cassette 516 has the window portion through which the coins are transported, the window portion may similarly have an openable and closable door, or the window portion may have an opening having such as size as to receive only the coin transported one by one by the coin transport unit 518, thereby preventing a person from putting a hand or an object in the coin cassette 516 and preventing a person from extracting the coin from the coin cassette 516. As described above, easy access to the coin stored in the coin cassette 516 is prevented, thereby enabling improvement of security.

For example, a coin processing unit of Glory is described in Japanese Laid-Open Patent Publication No. 2001-67526 and Japanese Laid-Open Patent Publication No. 2008-242690.

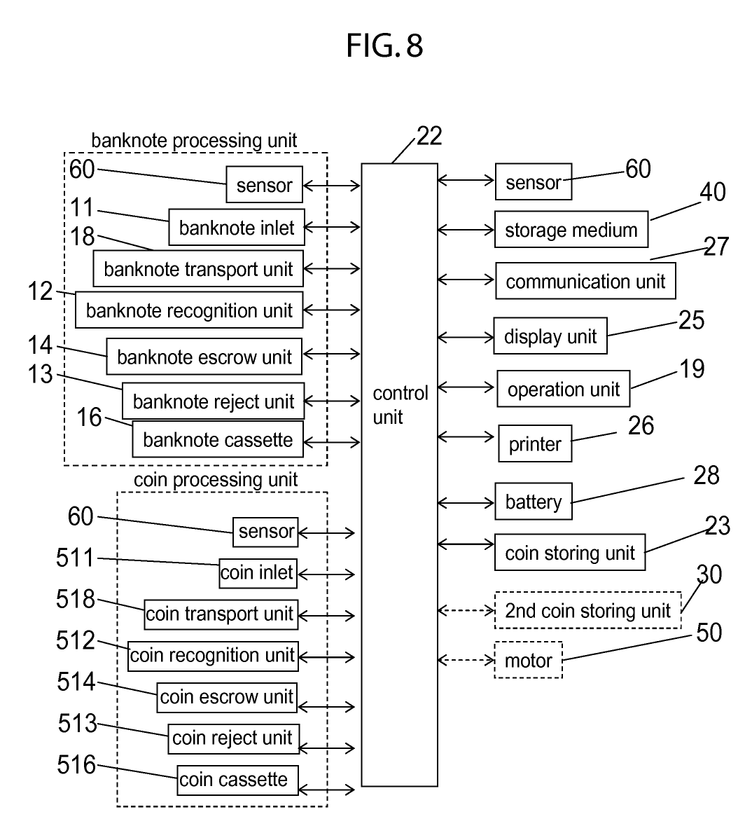

The respective units operating in accordance with operations performed by the other units or an operation performed by a user are connected to the control unit 22, and the operations performed by the respective units described above are controlled by the control unit 22 controlling the respective units, as shown in FIG. 8. The operations and the configurations of the respective units are the same as those described above in each of the above embodiments, and the description thereof is not provided.

Further, when the coin processing unit having the configuration as described above is provided, the functions and the operations in the banknote processing described above in each of the above embodiments are applicable to coins. When “banknote” is replaced with “coin” in the description of the above embodiments, the fundamental contents which are common among the above embodiments may be understood, and therefore detailed description for the coins is not provided.

As described above, the coin processing unit capable of recognizing and counting coins is able to prevent a mistake in counting coins and/or the like when a task of collecting coins and/or a task of replenishing the register with coins prepared as the change fund are performed, in a similar manner to that for banknotes.

Further, the collected coins are stored in the coin cassette 516 in a safe, thereby improving security.

Thus, while there have been shown, described, and pointed out features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined with regard to the claims appended hereto, and equivalents of the recitations therein.

We claim:

1. A currency collection and processing apparatus, comprising:
a housing;
a coin processing module disposed in the housing and configured to store a plurality of coins;
a banknote processing unit disposed in the housing having a banknote inlet configured to receive banknotes input into the apparatus, a banknote recognition unit configured to analyze the received banknotes, at least one banknote storing unit, and a transport unit configured to transport a banknote along a transport path connecting the inlet, the recognition unit, and the storing unit;
an input interface configured to input data;
a processing control unit configured to calculate at least one of a first value representing the plurality of coins stored in the coin processing module and a second value representing the received banknotes, and to process at least one of the inputted data and the first and second calculated values; and
an output device configured to output information to a user.

2. The currency collection and processing apparatus as recited in claim1, wherein the housing is configured to freely move the apparatus.

3. The currency collection and processing apparatus as recited in claim 2, further comprising motor driven wheels.

4. The currency collection and processing apparatus as recited in claim 1, wherein the input interface includes a communication interface configured to receive data.

5. The currency collection and processing apparatus as recited in claim 1, further comprising a safe.

6. The currency collection and processing apparatus as recited in claim 1, further comprising a paper processing unit configured to process and store at least one of a check, a coupon, a gift certificate, and a gift card.

7. The currency collection and processing apparatus as recited in claim 1, wherein the processing control unit computes a value of a change fund.

8. The currency collection and processing apparatus as recited in claim 7, wherein the apparatus allocates at least one of coins and banknotes corresponding to the value of the change fund.

9. The currency collection and processing apparatus as recited in claim 8, wherein the coins and banknotes allocated for the change fund is independent of coins and banknotes received by the mobile currency and collection apparatus.

10. The currency collection and processing apparatus as recited in claim 1, wherein the inputted data includes an anticipated value of currency to be received by the currency collection and processing apparatus.

11. The currency collection and processing apparatus as recited in claim 10, wherein the processing control unit compares the anticipated value of currency to at least one of the first and second values.

12. The currency collection and processing apparatus as recited in claim 7, wherein the anticipated value is user-settable.

13. The currency collection and processing apparatus as recited in claim 1, wherein the coin processing module includes at least one slot section, each slot section being configured to store a plurality of coins of common denomination.

14. The currency collection and processing apparatus as recited in claim 13, wherein the each coin slot section includes at least one scale indicating a number of coins stored in the respective slot selection.

15. The currency collection and processing apparatus as recited in claim 1, wherein the coin processing unit is configured to calculate at least one of number and an amount of coins based on weight of the coins.

16. The currency collection and processing apparatus as recited in claim 1, further comprising a display.

17. The currency collection and processing apparatus as recited in claim 1, further comprising a fault detection module.

18. A currency collection and processing system, comprising:
at least one cash storing apparatus having a first communications interface;
a currency collection and processing apparatus, comprising:
a housing;
a coin processing module disposed in the housing and configured to store a plurality of coins;
a banknote processing unit disposed in the housing having a banknote inlet configured to receive banknotes input into the apparatus, a banknote recognition unit configured to analyze the received banknotes, at least one banknote storing unit, and a transport unit configured to transport a banknote along a transport path connecting the inlet, the recognition unit, and the storing unit;
a second communication interface configured to transmit and receive data;
a processing control unit configured to calculate at least one of a first value representing the plurality of coins stored in the coin processing unit and a second value representing the received banknotes, and to process at least one of the received data and the first and second calculated values; and
an output device configured to output information to a user.

19. The currency collection and processing system as recited in claim 18, wherein the housing is configured to freely move the currency collection and processing apparatus.

20. The currency collection and processing system as recited in claim 18, wherein the at least one cash storing apparatus communicates via the first communication interface to the currency collection and processing apparatus an anticipated value of currency representing an amount of currency contained within the cash storing apparatus.

21. The currency collection and processing system as recited in claim 18, further comprising a central server communicating with the at least one cash storing apparatus and the currency collection and processing apparatus.

22. The currency collection and processing system as recited in claim 21, wherein at least one of the at least one cash storing apparatus, the currency collection and processing apparatus, and the central server is in communication with a management server.

23. The currency collection and processing system as recited in claim 18, wherein the first and second communication interfaces include wireless communication devices.

24. The currency collection and processing system as recited in claim 18, wherein the at least one cash storing apparatus and the currency collection and processing apparatus communicates via a storage medium.

25. The currency collection and processing system as recited in claim 18, wherein the processing control unit is configured to calculate a respective cash storing apparatus value representing at least one of coins and banknotes received from each of the at least one cash storing apparatus.

26. The currency collection and processing system as recited in claim 25, wherein the processing control unit is configured to process the respective cash storing apparatus values.

27. A method for collecting and processing currency, comprising the steps of:
receiving coins in a coin processing module configured to store a plurality of coins;
receiving banknotes in a banknote processing unit having a banknote inlet configured to receive banknotes, a banknote recognition unit configured to analyze the received banknotes, at least one banknote storing unit, and a transport path connecting the inlet, the recognition unit, and the storing unit;
inputting data including an anticipated value of currency to be received by the currency collection and processing apparatus;
calculating at least one of a first value representing the plurality of coins stored in the coin processing module and a second value representing the received banknotes, and processing at least one of the inputted data and the first and second calculated values; and
outputting information to a user.

28. The method as recited in claim 27, wherein the step of inputting data includes the step of receiving data via communication interface.

29. The method as recited in claim 27, where in the step of inputting data includes the step of receiving a value of change fund.

30. The method as recited in claim 29, further comprising the step of allocating coins and banknotes corresponding to the value of the change fund.
